(19) United States
(12) Patent Application Publication
(10) Pub. No.: US 2020/0194862 A1
(43) Pub. Date: Jun. 18, 2020

(54) WAVEGUIDE DEVICE, ANTENNA DEVICE, AND COMMUNICATION DEVICE

(71) Applicants: Nidec Corporation, Kyoto (JP); WGR Co., Ltd., Kyoto-city (JP)

(72) Inventors: Hiroyuki KAMO, Kyoto (JP); Hideki KIRINO, Kyoto-city (JP)

(21) Appl. No.: 16/716,648

(22) Filed: Dec. 17, 2019

(30) Foreign Application Priority Data
Dec. 18, 2018 (JP) 2018-236089

(51) Int. Cl. H01P 3/123; H01Q 21/06; H01P 5/18; H01Q 13/22

(52) U.S. Cl. CPC H01P 3/123; H01Q 13/22; H01P 5/182; H01Q 21/064

(57) ABSTRACT

A waveguide device includes a first electrical conductor including a first electrically conductive surface and a second electrical conductor including a second electrically conductive surface opposing the first electrically conductive surface. The second electrical conductor includes a through hole, a ridge-shaped waveguide protruding from the second electrically conductive surface, and electrically conductive rods protruding from the second electrically conductive surface. The waveguide includes an electrically-conductive waveguide surface opposing the first electrically conductive surface, and one end thereof extends into the through hole. The electrically conductive rods are located on opposite sides of the waveguide, each including a leading end opposing the first electrically conductive surface. The first electrical conductor or the second electrical conductor includes an electrically conductive wall protruding from the first electrically conductive surface or the second electrically conductive surface. The electrically conductive wall extends around the one end of the waveguide.

### CROSS REFERENCE TO RELATED APPLICATION

The present invention claims priority under 35 U.S.C. § 119 to Japanese Application No. 2018-236089 filed on Dec. 18, 2018, the entire contents of which are incorporated herein by reference.

### FIELD OF THE INVENTION

The present disclosure relates to a waveguide device, an antenna device, and a communication device.

### BACKGROUND

As waveguides having little propagation loss of electromagnetic waves, waveguides called the waffle-iron ridge waveguide (WRG) have recently been developed. For example, the specification of U.S. Pat. No. 8,779,995 and Kirino et al., “A 76 GHz Multi-Layered Phased Array Antenna Using a Non-Metal Contact Metamaterial Waveguide”, IEEE Transaction on Antennas and Propagation, Vol. 60, No. 2, February 2012, pp 840-853 and Syed Kamal Mustafa, “Hybrid Analog-Digital Beam-Steered Slot Antenna Array for mm-Wave Applications in Gap Waveguide Technology” disclose example structures of such waveguides. Each of the waveguide devices disclosed in these publications, as a whole, includes a pair of opposing electrically conductive plates. One of the electrically conductive plates has a ridge that protrudes toward the other electrically conductive plate, and a plurality of electrically conductive rods that are disposed in row and column directions on both sides of the ridge. The plurality of conductive rods constitute an artificial magnetic conductor. Via a gap, the electrically-conductive upper face of the ridge is opposed to the electrically conductive surface of the other electrically conductive plate. An electromagnetic wave having a wavelength that falls within a propagation stop band of the artificial magnetic conductor propagates in a space between this electrically conductive surface and the upper face of the ridge, in a manner of following along the ridge. In the present specification, a waveguide of this kind will be referred to as a WRG waveguide or a ridge waveguide. A WRG waveguide may be used, in e.g. an antenna device having one or more slots as an antenna element(s), as a waveguide for feeding the slots.

A WRG waveguide may be used in combination with a hollow waveguide. For example, Syed Kamal Mustafa, “Hybrid Analog-Digital Beam-Steered Slot Antenna Array for mm-Wave Applications in Gap Waveguide Technology” discloses an exemplary structure in which a ridge waveguide is connected to a hollow waveguide that extends along a perpendicular direction to the upper face of the ridge. Such structure may be used to construct a device in which an MMIC (Monolithic Microwave Integrated Circuit or Microwave and Millimeter wave Integrated Circuit) that is disposed on the rear side of an electrical conductor having a ridge is connected to the ridge waveguide.

It has been confirmed through computer simulations that the device disclosed in Syed Kamal Mustafa, “Hybrid Analog-Digital Beam-Steered Slot Antenna Array for mm-Wave Applications in Gap Waveguide Technology” operates across a wide frequency band. However, this device is structured so that a portion that connects the hollow waveguide and the ridge waveguide is surrounded by a metal wall, which makes it very difficult to actually fabricate this structure. It has been particularly difficult to apply a molding method that provides high mass producibility, e.g., using a die or the like, to the production of a device having the aforementioned structure.

### SUMMARY

Example embodiments of the present disclosure provide devices each having a structure in which a ridge waveguide and a hollow waveguide are connected, such that the structure is easier to mass-produce than conventional devices.

A waveguide device according to one example embodiment of the present disclosure includes a first electrical conductor including a first electrically conductive surface, and a second electrical conductor including a second electrically conductive surface opposing the first electrically conductive surface. The second electrical conductor includes a through hole, a ridge-shaped waveguide protruding from the second electrically conductive surface, and a plurality of electrically conductive rods protruding from the second electrically conductive surface. The waveguide includes an electrically-conductive waveguide surface opposing the first electrically conductive surface, and one end thereof extends into the through hole. The plurality of electrically conductive rods are located on opposite sides of the waveguide, each including a leading end opposing the first electrically conductive surface. The first electrical conductor or the second electrical conductor includes an electrically conductive wall protruding from the first electrically conductive surface or the second electrically conductive surface. The electrically conductive wall extends around the one end of the waveguide. The electrically conductive wall includes an inner surface opposing an end surface at the one end of the waveguide and opposite side surfaces at the one end of the waveguide. A first waveguide is defined between the waveguide surface and the first electrically conductive surface. A second waveguide is defined inward of the electrically conductive wall and inside the through hole, the second waveguide being connected to the first waveguide.

According to example embodiments of the present disclosure, devices that each include a structure in which a ridge waveguide and a hollow waveguide are connected, such that the structure is easier to mass-produce than conventional devices.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a plan view showing a communication device 500 which is constructed by using a waveguide device according to an illustrative first example embodiment of the present disclosure.

FIG. 2 is a diagram showing enlarged one antenna device that is shown in FIG. 1.

FIG. 3A is a plan view showing the antenna device, with a first conductor removed therefrom.

FIG. 3B is a diagram showing the structure at the rear side of a second conductor.

FIG. 4A is a perspective view showing an exemplary structure of a respective conversion section between a hollow waveguide and a WRG waveguide according to an example embodiment of the present disclosure.

FIG. 4B is a diagram where the first conductor shown in FIG. 4A is illustrated as if translucent.

FIG. 5 is a perspective view showing the structure at the front side of the second conductor near conversion sections.

FIG. 6A is a perspective view showing the structure of a first conductor near conversion sections according to an example embodiment of the present disclosure.

FIG. 6B is a diagram showing a variant of the first conductor.

FIG. 7A is a perspective view showing the waveguide device as viewed from the rear side.

FIG. 7B is a perspective view showing the waveguide device of FIG. 7A, with an MSL module removed therefrom.

FIG. 7C is a perspective view where, in the waveguide device shown in FIG. 7A, portions of the MSL module are illustrated as if transparent.

FIG. 8 is a diagram showing an example embodiment of the present disclosure in which an IC-mounted substrate is disposed on the rear side of the antenna device.

FIG. 9A is a diagram showing enlarged a portion of a radiating section of the first conductor.

FIG. 9B is a diagram showing the device of FIG. 9A, with the second conductor removed therefrom.

FIG. 9C is a diagram showing the radiating section of the first conductor in FIG. 9B as viewed from the rear side.

FIG. 10A is a diagram showing a variant of the waveguide device in FIG. 4A.

FIG. 10B is a front view of the waveguide device shown in FIG. 10A.

FIG. 11A is a perspective view showing a waveguide device according to an illustrative second example embodiment of the present disclosure.

FIG. 11B is a perspective view showing the waveguide device of FIG. 11A, with the first conductor removed therefrom.

FIG. 11C is a diagram showing a variant of the waveguide device illustrated in FIG. 11A.

FIG. 11D is a plan view showing the waveguide device according to the variant in FIG. 11C, with the first conductor removed therefrom.

FIG. 12A is a perspective view showing a waveguide device according to an illustrative third example embodiment of the present disclosure.

FIG. 12B is a perspective view showing the waveguide device of FIG. 12A, with the first conductor removed therefrom.

FIG. 13 is a diagram showing the structure at the rear side of the second conductor according to the third example embodiment.

FIG. 14A is a perspective view showing a waveguide device according to an illustrative fourth example embodiment of the present disclosure.

FIG. 14B is a perspective view showing the waveguide device of FIG. 14A, with the first conductor removed therefrom.

FIG. 15 is a diagram showing a first conductor according to the fourth example embodiment as viewed from the rear side.

FIG. 16 is a diagram showing a second conductor according to the fourth example embodiment as viewed from the rear side.

FIG. 17 is a diagram showing the waveguide device in FIG. 14A, with the second conductor being rendered invisible.

FIG. 18 is a perspective view schematically showing the construction of a waveguide device.

FIG. 19A is a diagram schematically showing a cross-sectional construction of a waveguide device according to an example embodiment of the present disclosure.

FIG. 19B is a diagram schematically showing a cross-sectional construction of a waveguide device according to an example embodiment of the present disclosure.

FIG. 20 is a perspective view schematically showing the waveguide device, illustrated so that the spacing between two conductors is exaggerated.

FIG. 21 is a diagram showing an exemplary range of dimension of each member in the waveguide device.

FIG. 22A is a cross-sectional view showing a variant of the waveguide device.

FIG. 22B is a cross-sectional view showing another variant of the waveguide device.

FIG. 22C is a cross-sectional view showing still another variant of the waveguide device.

FIG. 22D is a cross-sectional view showing still another variant of the waveguide device.

FIG. 22E is a cross-sectional view showing still another variant of the waveguide device.

FIG. 22F is a cross-sectional view showing still another variant of the waveguide device.

FIG. 22G is a cross-sectional view showing still another variant of the waveguide device.

FIG. 23A is a cross-sectional view showing still another variant of the waveguide device.

FIG. 23B is a cross-sectional view showing still another variant of the waveguide device.

FIG. 24A is a diagram schematically showing an electromagnetic wave that propagates in a gap between the waveguide and the conductor.

FIG. 24B is a diagram schematically showing a cross section of a hollow waveguide according to an example embodiment of the present disclosure.

FIG. 24C is a cross-sectional view showing an implementation of an example embodiment of the present disclosure where two waveguides are provided on the conductor.

FIG. 24D is a diagram schematically showing a cross section of a waveguide device according to an example embodiment of the present disclosure in which two hollow waveguides are placed side-by-side.

FIG. 25A is a perspective view schematically showing an exemplary construction of a slot antenna array according to an example embodiment of the present disclosure.

FIG. 25B is a cross-sectional view of the slot antenna array shown in FIG. 25A.

### DETAILED DESCRIPTION

First, the schematic outlines of some example embodiments of the present disclosure will be described.

A waveguide device according to an example embodiment of the present disclosure includes a first electrical conductor including a first electrically conductive surface; and a second electrical conductor including a second electrically conductive surface opposing the first electrically conductive surface. The second electrical conductor includes a through hole; a ridge-shaped waveguide protruding from the second electrically conductive surface; and a plurality of electrically conductive rods protruding from the second electrically conductive surface. The waveguide has an electrically-conductive waveguide surface opposing the first electrically conductive surface, and one end thereof extends into the through hole. The plurality of electrically conductive rods are located on opposite sides of the waveguide, each having a leading end opposing the first electrically conductive surface. The first electrical conductor or the second electrical conductor comprises an electrically conductive wall protruding from the first electrically conductive surface or the second electrically conductive surface. The electrically conductive wall extends around the one end of the waveguide. The electrically conductive wall includes an inner surface opposing an end surface at the one end of the waveguide and opposite side surfaces at the one end of the waveguide. A first waveguide is defined between the waveguide surface and the first electrically conductive surface. A second waveguide is defined inward of the electrically conductive wall and inside the through hole, the second waveguide being connected to the first waveguide.

The first waveguide is a ridge waveguide as aforementioned. The second waveguide is a hollow waveguide. With the above construction, a portion where the hollow waveguide and the ridge waveguide are connected does not need to be completely surrounded by a metal wall. This allows the waveguide device to be produced relatively easily. For example, by a molding method that provides high mass producibility, e.g., using a die or the like, a waveguide device having the above structure can be produced.

The inner surface of the electrically conductive wall may include a first inner surface opposing the end surface at the one end of the waveguide; and a pair of second inner surfaces continuous with the first inner surface, respectively opposing the opposite side surfaces at the one end of the waveguide. The region between the end surface of the waveguide and the first inner surface constitutes the second waveguide, i.e., a portion of the hollow waveguide.

The electrically conductive wall may include: a first portion which is substantially perpendicular to the direction that the waveguide extends and a pair of second portions which are respectively continuous with opposite ends of the first portion and which are substantially parallel to the direction that the waveguide extends. In that case, a cross section of the electrically conductive wall as taken on a plane which is parallel to the waveguide surface presents a U shape. Note that the first portion and the second portions do not need to be perpendicularly continuous, but may be continuous in a manner of presenting a curve.

The electrically conductive wall may be provided either for the first electrical conductor or for the second electrical conductor. In one example embodiment, the second electrical conductor comprises the electrically conductive wall. Specific examples of such example embodiments will be described later as a “first example embodiment”, a “second example embodiment”, and a “third example embodiment”. In these example embodiments, the electrically conductive wall is disposed so as to extend around the one end of the waveguide and around the through hole. The first electrical conductor has a slit or recess accommodating at least a portion of the electrically conductive wall.

An interspace may exist between an inner surface of the slit or recess of the first electrical conductor and a surface of the electrically conductive wall. For example, an interspace may exist between a bottom face of the recess and a top surface of the electrically conductive wall. Moreover, an interspace may exist between an inner side surface of the slit or recess and a side surface (i.e., inner side surface or outer side surface) of the electrically conductive wall. The inventors have found that, even in the presence of such interspaces, an electromagnetic wave can be transmitted satisfactorily between the first waveguide (ridge waveguide) and the second waveguide (hollow waveguide). Since such interspaces are tolerated, the precision that is required of the dimensional design for the first electrical conductor and the second electrical conductor can be relaxed, thus providing an increased mass producibility.

In another example embodiment, the first electrical conductor comprises the electrically conductive wall. A specific example of such an example embodiment will be described later as a “fourth example embodiment”. In such an example embodiment, a portion of the electrically conductive wall is located inside the through hole. The electrically conductive wall may extend from the first electrically conductive surface of the first electrical conductor, through the through hole, and beyond the second electrical conductor.

The second electrical conductor may further comprise a third electrically conductive surface opposite to the second electrically conductive surface. In addition to the waveguide (first waveguide), the second electrical conductor may further comprise a ridge-shaped second waveguide protruding from the third electrically conductive surface, one end of the second waveguide extending into the through hole so as to be continuous with the one end of the first waveguide. In such construction, a third waveguide is defined along a top surface of the second waveguide, and the third waveguide is connected to the second waveguide.

The waveguide device may further comprise a microstrip line connected to a portion of the top surface of the second waveguide. With such construction, electromagnetic waves can be mutually transmitted between the microstrip line and the third waveguide. The microstrip line may be connected to a microwave integrated circuit, for example.

The waveguide device may further comprise a third electrical conductor having a fourth electrically conductive surface that is in contact with the third electrically conductive surface. The second electrical conductor may include a groove having an electrically-conductive inner surface at the third electrically conductive surface side. The second waveguide may be inside the groove. At least a portion of the top surface of the second waveguide may be opposed to the fourth electrically conductive surface. In such construction, inside the groove, a hollow waveguide extending along the second waveguide is created as a third waveguide. The third electrical conductor may be a microstrip line module that includes the aforementioned microstrip line.

The waveguide device may further comprise a third electrical conductor having a fourth electrically conductive surface opposing the third electrically conductive surface. The second electrical conductor may further comprise a plurality of second electrically conductive rods protruding from the third electrically conductive surface and being located on opposite sides of each of the plurality of second waveguides, each second electrically conductive rod having a leading end opposing the fourth electrically conductive surface. At least a portion of the top surface of the second waveguide may be opposed to the fourth electrically conductive surface. In such construction, between the top surface of the second waveguide and the fourth electrically conductive surface, a ridge waveguide is created as the third waveguide. The third electrical conductor may be a microstrip line module that includes the aforementioned microstrip line.

Note that the fourth electrically conductive surface may be covered with a layer of dielectric. In other words, the fourth electrically conductive surface may not be located at the outermost surface of the third electrical conductor. Such a dielectric layer may be a solder resist, or a plate that is made of a dielectric. In the case where the dielectric layer is a plate, an electrically-conductive layer may further be disposed thereon. In the case where such an electrically-conductive layer is a metal foil in strip shape, a microstrip line can be constructed by the electrically-conductive layer in strip shape and the fourth electrically conductive surface, as well as the dielectric layer therebetween.

The second electrical conductor may further comprise a second electrically conductive wall protruding from the third electrically conductive surface. The second electrically conductive wall may extend around the one end of the second waveguide and around the through hole. A top surface of the second electrically conductive wall may be in contact with the third electrical conductor. The top surface of the second electrically conductive wall may be in contact with the fourth electrically conductive surface of the third electrical conductor, or in contact with a dielectric layer covering the fourth electrically conductive surface. Moreover, an interspace of 50 μm or less may exist between the top surface of the second electrically conductive wall and the surface of the third electrical conductor.

Alternatively, in the case where the first electrical conductor comprises the electrically conductive wall, the electrically conductive wall may extend beyond through hole, and the top surface of the electrically conductive wall may be in contact with the fourth electrically conductive surface.

The second electrical conductor may comprise a plurality of through hole including the said through hole and a plurality of waveguides including the said waveguide. The first electrical conductor or the second electrical conductor may comprise a plurality of electrically conductive walls including the said electrically conductive wall. The plurality of electrically conductive rods may be disposed around and between the plurality of waveguides. Each of the plurality of waveguides may be a ridge-shaped waveguide protruding from the second electrically conductive surface, having an electrically-conductive waveguide surface opposing the first electrically conductive surface, and one end thereof extending into one of the plurality of through holes. Each of the plurality of electrically conductive walls may protrude from the first electrically conductive surface or the second electrically conductive surface, and extend around the one end of one of the plurality of waveguides. A plurality of first waveguides may be defined between the waveguide surfaces of the plurality of waveguides and the first electrically conductive surface. A plurality of second waveguides respectively connected to the plurality of first waveguides may be defined inward of the plurality of electrically conductive walls and inside the plurality of through holes.

With the above construction, a plurality of first waveguides (i.e., ridge waveguides) and a plurality of second waveguides (i.e., hollow waveguides) can be connected.

The second electrical conductor may comprise the plurality of electrically conductive walls. Each of the plurality of electrically conductive walls may extend around the one end of one of the plurality of waveguides and around one of the plurality of through holes. The first electrical conductor may include a plurality of slits or a plurality of recesses each accommodating at least a portion of a corresponding one of the plurality of electrically conductive walls. At least one of the plurality of slits or the plurality of recesses has an associated interspace between an inner side surface thereof and a side surface of one of the plurality of electrically conductive walls.

The plurality of waveguides may include two adjacent waveguides. The plurality of electrically conductive walls may include two adjacent electrically conductive walls. The two electrically conductive walls may comprise a common portion located between the respective one end of the two adjacent waveguides. In that case, the two electrically conductive walls constitute a continuous piece.

The common portion may include at a top thereof a groove extending along a direction that the two waveguides extend.

An antenna device according to an example embodiment of the present disclosure comprise: any of the aforementioned waveguide devices; and one or more antenna elements element connected to the waveguide device.

The first electrical conductor may include one or more slots functioning as the one or more antenna elements. The one or more slots may be opposed to the waveguide surface of the waveguide.

A communication device according to another example embodiment of the present disclosure comprises: any of the above antenna devices; and a microwave integrated circuit connected to the antenna device.

Hereinafter, example embodiments of the present disclosure will be described more specifically. Note however that unnecessarily detailed descriptions may be omitted. For example, detailed descriptions on what is well known in the art or redundant descriptions on what is substantially the same constitution may be omitted. This is to avoid lengthy description, and facilitate the understanding of those skilled in the art. The accompanying drawings and the following description, which are provided by the inventors so that those skilled in the art can sufficiently understand the present disclosure, are not intended to limit the scope of claims. In the present specification, identical or similar constituent elements are denoted by identical reference numerals.

### First Example Embodiment

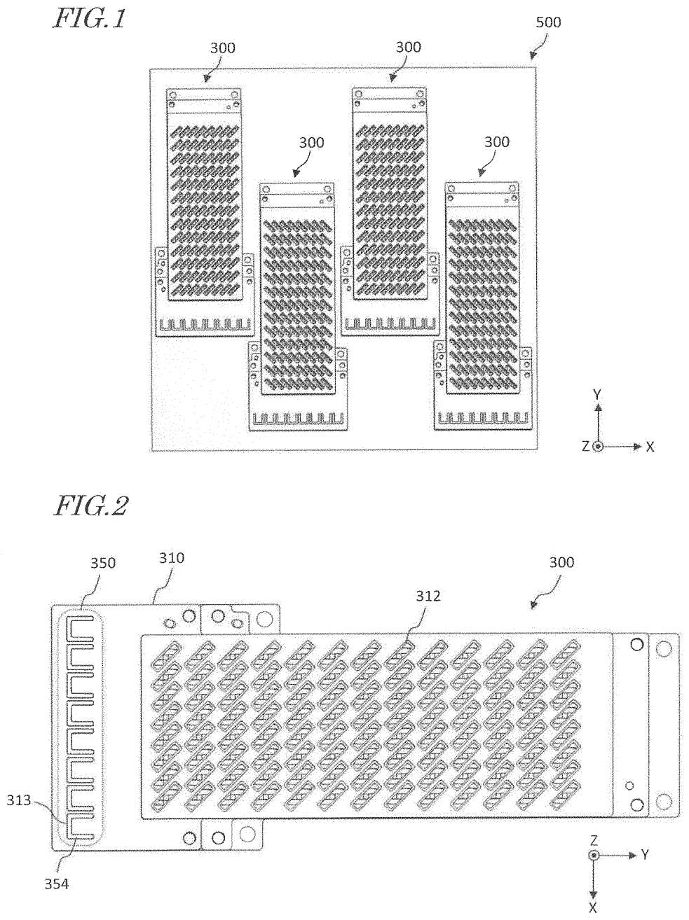

FIG. 1 is a plan view showing a communication device 500 which is constructed by using a waveguide device according to an illustrative first example embodiment of the present disclosure. FIG. 1A and FIG. 1B show XYZ coordinates along X, Y and Z directions which are orthogonal to one another. Hereinafter, the construction according to any example embodiment of the present disclosure will be described by using this coordinate system. The +Z direction will be referred to as the “front side”, and the −Z direction will be referred to as the “rear side”. The “front side” means the side at which an electromagnetic wave is radiated or the side at which an electromagnetic wave arrives, whereas the “rear side” means the opposite side to the front side. Note that any structure appearing in a figure of the present application is shown in an orientation that is selected for ease of explanation, which in no way should limit its orientation when an example embodiment of the present disclosure is actually practiced. Moreover, the shape and size of a whole or a part of any structure that is shown in a figure should not limit its actual shape and size.

FIG. 1 shows the structure of the communication device 500 on the front side. The communication device 500 includes four antenna devices 300. The four antenna devices 300 are arranged along the X direction so as to be mutually shifted in position regarding the Y direction, in such a manner that the position of every other antenna device 300 regarding the Y direction is identical. Such an arrangement is referred to as a “staggered arrangement”. Each antenna device 300 is connected to a microwave integrated circuit such as an MMIC and an electronic circuit such as a signal processing circuit, and performs at least one of radiation and reception of electromagnetic waves. Each antenna device 300 is small in size, such that the dimension of each antenna device 300 along the Y direction may be on the order of 20 cm, for example. Note that the number and arrangement of antenna devices 300 that are included in the communication device 500 may be adapted to the application, without being limited to the number and arrangement illustrated.

FIG. 2 is a diagram showing enlarged one of the antenna devices 300 shown in FIG. 1. At a left end as shown in FIG. 2, the antenna device 300 includes a plurality of hollow waveguides 350 each extending along the Z direction. The plurality of hollow waveguides 350 are located inside the antenna device 300, and are arranged along the X direction. Each U-shaped portion shown in FIG. 2 represents a top surface of an electrically conductive wall 354 that is located inside the antenna device 300.

The antenna device 300 includes a plate-like first electrical conductor 310. The first conductor 310 has a plurality of U-shaped slits 313 (i.e., through holes) at a left end as shown in FIG. 2. The plurality of slits 313 respectively accommodate leading ends of the plurality of conductive walls 354. The first conductor 310 further includes a plurality of slot antenna elements 312 arranged in a two-dimensional array along the X direction and along the Y direction. In the first conductor 310, the portion where these slot antenna elements 312 are disposed is referred to as a “radiating section”. Each slot antenna element 312 is used for the radiation or reception of electromagnetic waves. In the present example embodiment, the opening at the front side of each slot antenna element 312 extends along a direction which is inclined by 45 degrees with respect to the X direction. Without being limited to the illustrated direction, the direction in which the opening at the front side of each slot antenna element 312 may be any arbitrary direction that is inclined with respect to the Y direction. Each slot antenna element 312 radiates an electromagnetic wave having a field component along a direction which is perpendicular to the direction in which that opening extends. In the case where the antenna device 300 is used for reception, each slot antenna element 312 functions to take an electromagnetic wave arriving from the external space into a WRG waveguide on the rear side of the first conductor 310.

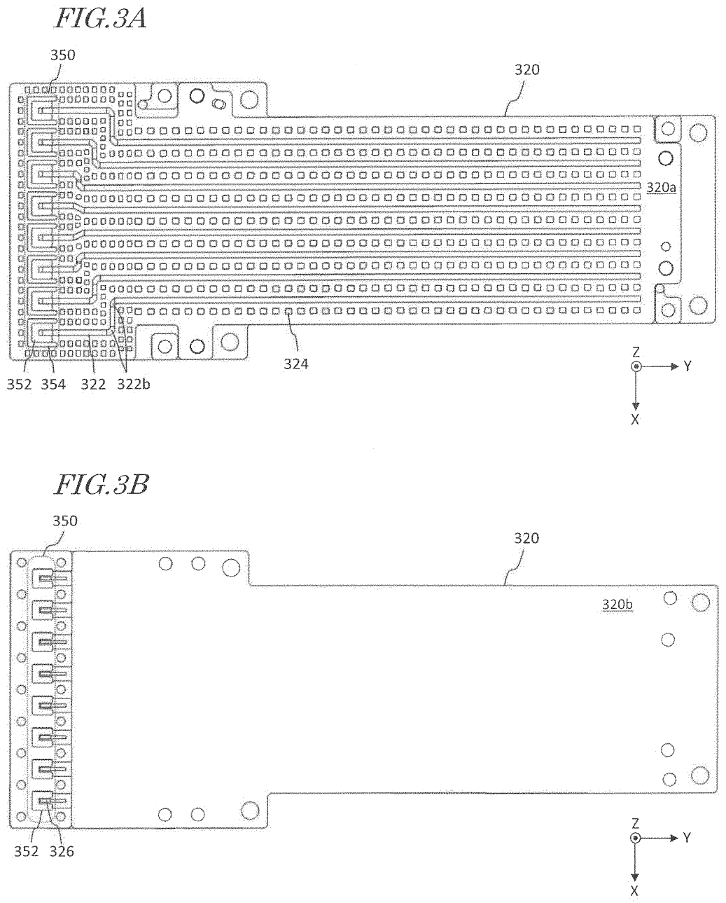

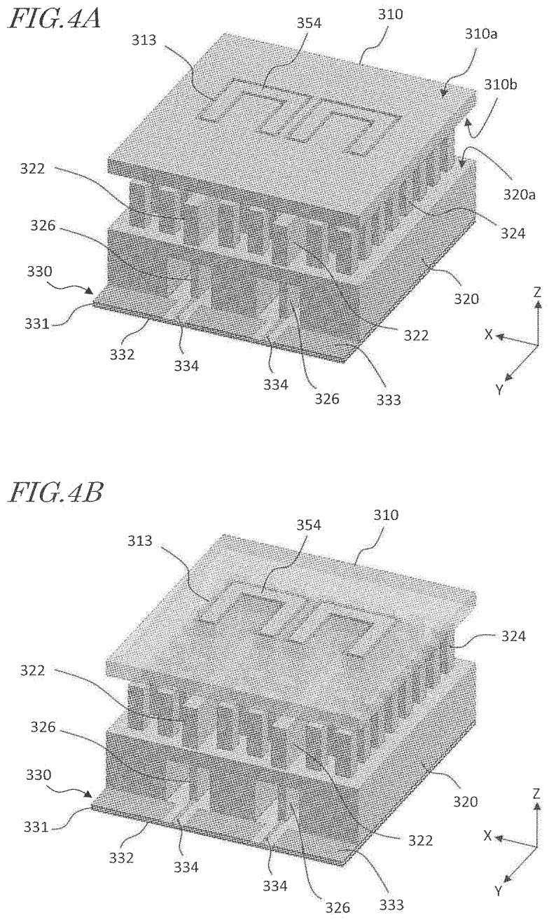

FIG. 3A is a plan view showing the antenna device 300, with the first conductor 310 removed therefrom. The antenna device 300 further includes plate-like second conductors 320 which are opposed to the first conductor 310 via a gap. FIG. 3A shows the structure at the front side of the second conductor 320. The second conductor 320 includes: a second conductive surface 320a opposing a first electrically conductive surface on the rear side of the first conductor 310; and a plurality of waveguides 322 and a plurality of electrically conductive rods 324 protruding from the second conductive surface 320a. Each of the plurality of waveguides 322 has a ridge-shaped structure. Each waveguide 322 has an electrically-conductive waveguide surface opposing the first conductive surface on the rear side of the first conductor 310. The plurality of conductive rods 324 are disposed around and between the plurality of waveguides 322. Each conductive rod 324 has a root that is connected to the second conductive surface 320a and a leading end opposing the first conductive surface on the rear side of the first conductor 310. While each illustrated conductive rod 324 is shaped as a rectangular solid, it may have any other shape, e.g., a circular cylinder, frustum of a pyramid, or a frustum of a cone.

As a whole, the plurality of waveguides 322 are arranged along the X direction. Each waveguide 322 generally extends along the Y direction. However, each waveguide 322 according to the present example embodiment has two bends 322b. At each bend 322b, a change is made in the direction in which the waveguide 322 extends. In the present example embodiment, the bends 322b are recesses. The bends 322b being recessed restrains reflection of signal waves from occurring at the bends 322b. Each waveguide 322 includes a portion that linearly extends along the Y direction; this portion is opposed to 13 slot antenna elements 312 flanking one another along the Y direction, among the plurality of slot antenna elements 312 shown in FIG. 2.

The plurality of conductive rods 324 are disposed on opposite sides of each waveguide 322. The plurality of conductive rods 324 function as an artificial magnetic conductor. With such structure, the aforementioned WRG waveguide is created between the waveguide surface of each waveguide 322 and the conductive surface on the rear side of the first conductor 310.

At the left end as shown in FIG. 3A, the second conductor 320 has a plurality of through holes 352 and a plurality of U-shaped conductive walls 354 respectively partially surrounding the plurality of through holes 352. The through holes 352 and the conductive walls 354 constitute the plurality of hollow waveguides 350 extending along the Z direction. One end of each waveguide 322 extends into the hollow waveguide 350. Via such structure, a WRG waveguide (first waveguide) and a hollow waveguide 350 (second waveguide) are connected.

In the present example embodiment, there are eight waveguides 322; however, the number of waveguides 322 may be any number equal to or greater than one. In accordance with the number and arrangement of waveguides 322, the numbers and arrangements of through holes 352 and conductive walls 354 and the number and arrangement of the plurality of slot antenna elements 312 of the first conductor 310 are to be determined.

FIG. 3B is a diagram showing the structure at the rear side of the second conductor 320. The plurality of through holes 352 open in a third conductive surface 320b on the rear side of the second conductor 320. On its rear side, the second conductor 320 includes a plurality of relatively short, ridge-shaped waveguides 326 (second waveguides). One end of each waveguide 326 protrudes into the through hole 352, while the other end is connected to a microwave integrated circuit via a transmission line such as a microstrip line not shown.

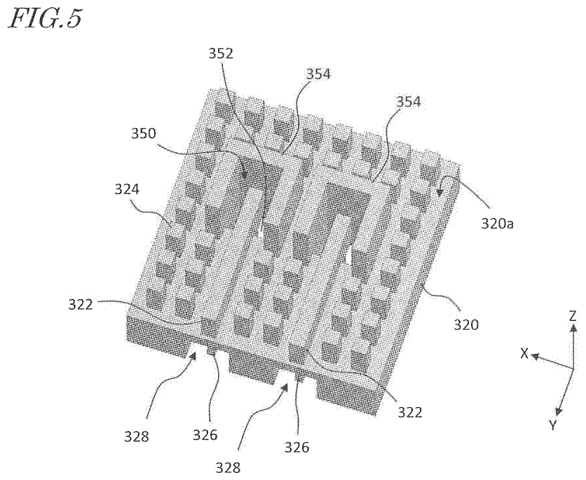

FIG. 4A is a perspective view showing an exemplary structure of a respective conversion section between a hollow waveguide and a WRG waveguide. In FIG. 4A, for simplicity, only the structure near conversion sections between two adjacent hollow waveguides and two adjacent WRG waveguides is shown. Such structure for conversion sections is applicable not only to the antenna device 300 according to the present example embodiment, but also to any waveguide device. Hereinafter, the device shown in FIG. 4A may be referred to as a “waveguide device”. FIG. 4B is a diagram where the first conductor 310 is illustrated as if translucent for ease of understanding. FIG. 5 is a perspective view showing the structure at the front side of the second conductor 320 near the conversion sections.

As shown in FIG. 5, the second conductor 320 includes a plurality of U-shaped conductive walls 354 protruding from the conductive surface 320a. Each conductive wall 354 constitute three wall faces of the hollow waveguide 350. Each conductive wall 354 is part of the second conductor 320. By a forming method using a die, for example, each conductive wall 354 and other portions composing the second conductor 320 can be produced as a continuous piece.

The plurality of through holes 352 in the second conductor 320 are respectively located inward of the plurality of conductive walls 354. Each conductive wall 354 has a first inner surface opposing an end surface at one end of the waveguide 322, and a pair of second inner surfaces respectively opposing opposite side surfaces at the one end of the waveguide 322. In the example of FIG. 5, each conductive wall 354 includes a first portion which is substantially perpendicular to the Y direction (along which the waveguide 322 extends) and a pair of second portions which are substantially parallel to the Y direction. The pair of second portions are connected perpendicularly to opposite ends of the first portion. The first portion and the pair of second portions of each conductive wall 354 may have the same height; accordingly, the top surface of each conductive wall 354 has a flat U shape. The inner surface of each conductive wall 354 partially surrounds the through hole 352, i.e., on three of the four sides of the opening of the through hole 352. The conductor 354 may have other structures. For example, the conductive wall 354 may be structured so that its inner surface is smoothly curved. One end of each waveguide 322 extends into the region that is partially surrounded by the conductive wall 354, and protrudes into the through hole 352. Inside the through hole 352, this protruding portion is continuous with the waveguide 326 that is located at the rear side of the second conductor 320.

The plurality of conductive rods 324 are disposed around the plurality of waveguides 322 and around the plurality of conductive walls 354. Between two adjacent waveguides 322, two rows of conductive rods 324 are disposed. No conductive rods 324 are provided between any two adjacent conductive walls 354. The number and arrangement of conductive rods 324 are not limited to what is illustrated in the figure, but may be determined as appropriate, in accordance with the required characteristics of the waveguide device.

On its rear side, the second conductor 320 includes a plurality of grooves 328 extending along the Y direction, and a plurality of ridge-shaped waveguides 326 respectively located inside the grooves 328. Each groove 328 has an electrically-conductive inner surface. One end of each waveguide 326 on the rear side protrudes into the through hole 352, so as to be continuous with one end of the waveguide 322 on the front side.

Each of the first conductor 310 and the second conductor 320 may be fabricated by forming a plating layer on the surface of an electrically insulative material, e.g., resin, for example. In that case, each conductor includes a dielectric member defining the shape of the conductor, and a plating layer of electrically conductive material that covers the surface of the dielectric member. As the electrically conductive material composing the plating layer, a metal such as magnesium may be used, for example. It is not necessary for the entire shape of each conductor to be defined by the dielectric member. A portion of each conductor may have its shape directly defined by a metal member, for example. Furthermore, instead of a plating layer, a layer of electrical conductor may be formed by vapor deposition or the like. Each conductor may be fabricated through metalworking, such as casting, forging, or the like. Each conductor may be shaped by machining a metal plate. Each conductor may be shaped by die-casting or the like.

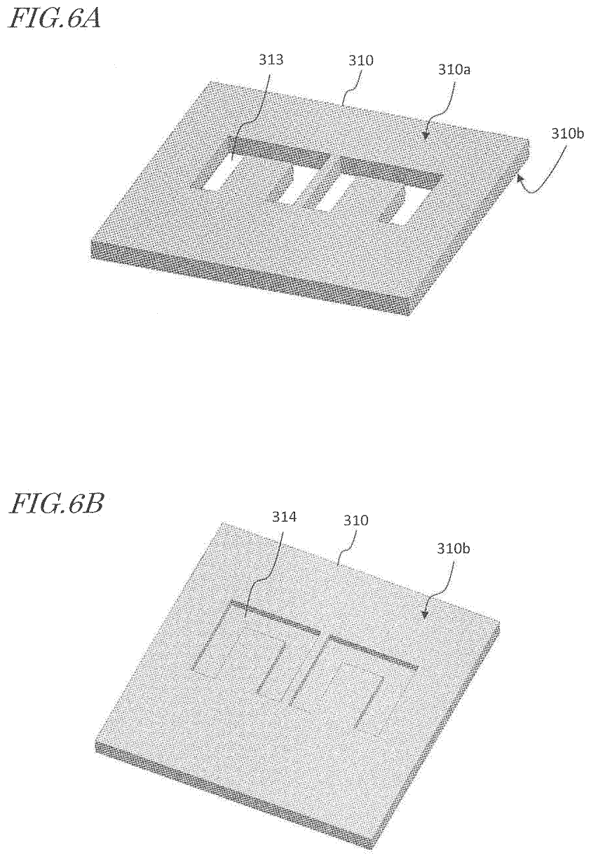

FIG. 6A is a perspective view showing the structure of a first conductor 310 near the conversion sections. The first conductor 310 according to the present example embodiment is a plate of metal, for example. The first conductor 310 has a conductive surface 310a on the front side, a first conductive surface 310b on the rear side, and a plurality of U-shaped slits 313. As shown in FIG. 4A, leading ends of the plurality of conductive walls 354 are accommodated inside the plurality of slits 313. A gap may exist between the inner surface of each slit 313 of the first conductor 310 and at least a portion of the side surface of the leading end of the conductive wall 354.

Each hollow waveguide 350 extends from the rear side of the second conductor 320 to the first conductive surface 310b on the rear side of the first conductor 310, where it bends in the Y direction, so as to become connected to a WRG on the waveguide 322. This connecting portion is referred to as a “conversion section” in the present specification. If the connection were between two hollow waveguides, a hollow waveguide extending along the Z direction and a hollow waveguide extending along the Y direction would need to be completely joined. However, the inventors have found that, in the case of connecting a WRG and a hollow waveguide, a gap may be allowed to exist between the conductive wall 354 (as a portion of the hollow waveguide extending along the Z direction) and the first conductor 310. In the example of FIG. 4A, the thickness of the conductive wall 354 is smaller than the width of the U-shaped slit 313. Therefore, the leading end of the conductive wall 354 is loose-fitted in the U-shaped slit 313.

FIG. 6B is a diagram showing a variant of the first conductor 310. FIG. 6B shows the structure of the first conductor 310 as viewed from the rear side. In this example, the first conductor 310 has a plurality of U-shaped recesses 314, rather than slits 313, in the first conductive surface 310b on the rear side. In the U-shaped recesses 314, the leading ends of U-shaped conductive walls 354 are fitted. With such structure, too, conversion sections can be constituted between hollow waveguides 350 and WRG waveguides. The leading end of each conductive wall 354 and the bottom face of each U-shaped recess 314 may be interspaced, or in contact with each other.

In either one of the constructions of FIG. 6A and FIG. 6B, an interspace exists between the side surface at the leading end of each conductive wall 354 and the inner surface of each U-shaped slit 313 or the side surface of each U-shaped recess 314. This makes it easier to control the dimensions and assembly of the first conductor 310 and the second conductor 320. The interspace might be abolished so that the leading ends of the conductive walls 354 are press-fitted in the slits 313 or the recesses 314 in the first conductor 310. Even under a press-fit design, however, fluctuations in the dimensions of some members during manufacture may locally create interspaces, or result in a state resembling loose fit. In a conventional construction where two hollow waveguides are connected, such an interspace will cause characteristic deteriorations, and is not tolerated. However, the conversion section between a hollow waveguide and a WRG according to the present example embodiment is adapted to tolerate existence of an interspace to begin with, and thus no such problem will occur. Moreover, each loose-fitted portion or press-fitted portion may be irradiated with laser or the like to weld the two members together, thus integrating the conductive wall 354 and the first conductor 310. Generally speaking, it is difficult to completely restrain blowholes or other welding defects from occurring at a welded portion; however, such defects will not be problematic to the present example embodiment.

Note that the shape of the slits 313 or recesses 314 in the first conductor 310 is not limited to a U shape. The shape of the slits 313 or recesses 314 may differ depending on the shape of the leading end of each conductive wall 354. For example, when the leading end of each conductive wall 354 has an arc shape, each slit 313 or recess 314 in the first conductor 310 may also have an arc shape.

The waveguide device shown in FIG. 4A further includes a microstrip line (MSL) module 330 on the rear side of the second conductor 320. The MSL module 330 includes a dielectric substrate 331, a first ground conductor 332 on the rear side, a second ground conductor 333 on the front side, and a plurality of strip conductors 334. The first ground conductor 332 is provided on the surface at the rear side of the dielectric substrate 331. The plurality of strip conductors 334 are provided on the surface at the front side of the dielectric substrate 331. Within the front surface of the dielectric substrate 331, the second ground conductor 333 is provided around the plurality of strip conductors 334. From such structure, a plurality of microstrip lines are constituted. The plurality of strip conductors 334 extend along the Y direction, and are respectively in contact with part of the top surfaces of the plurality of waveguides 326 on the rear side. The second ground conductor 333 is in contact with the third conductive surface 320b on the rear side of the second conductor 320.

In the present example embodiment, the MSL module 330 corresponds to the aforementioned “third conductor”, whereas the second ground conductor 333 corresponds to the aforementioned “fourth conductive surface”. A portion of the top surface of the second waveguide 326 is in contact with the strip conductor 334. Since the first ground conductor 332 is located on the rear side of the dielectric substrate 331, the portion of the top surface is opposed to the first ground conductor 332 with the dielectric substrate 331 interposed therebetween. Moreover, the first ground conductor 332 and the second ground conductor 333 are connected by way of a via not shown.

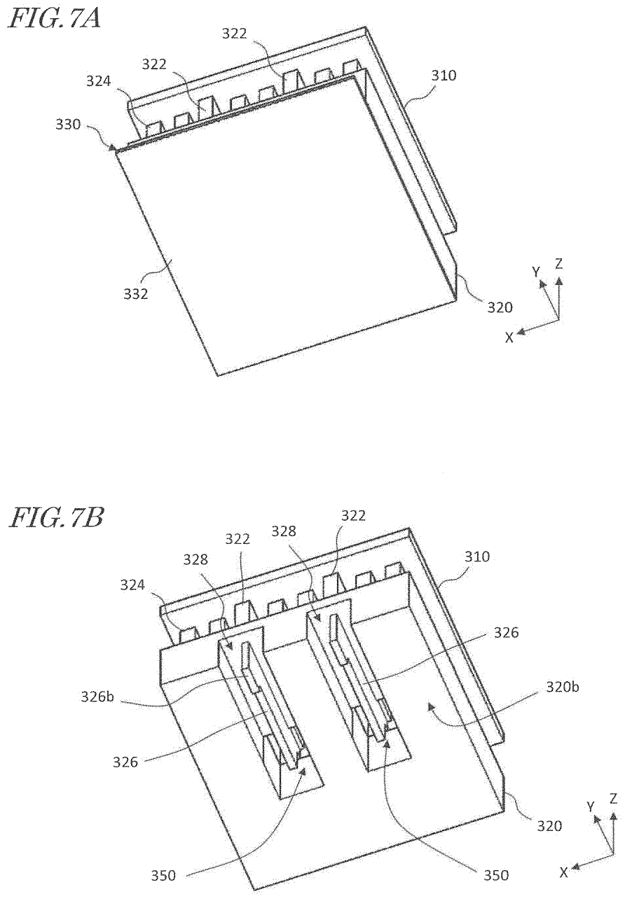

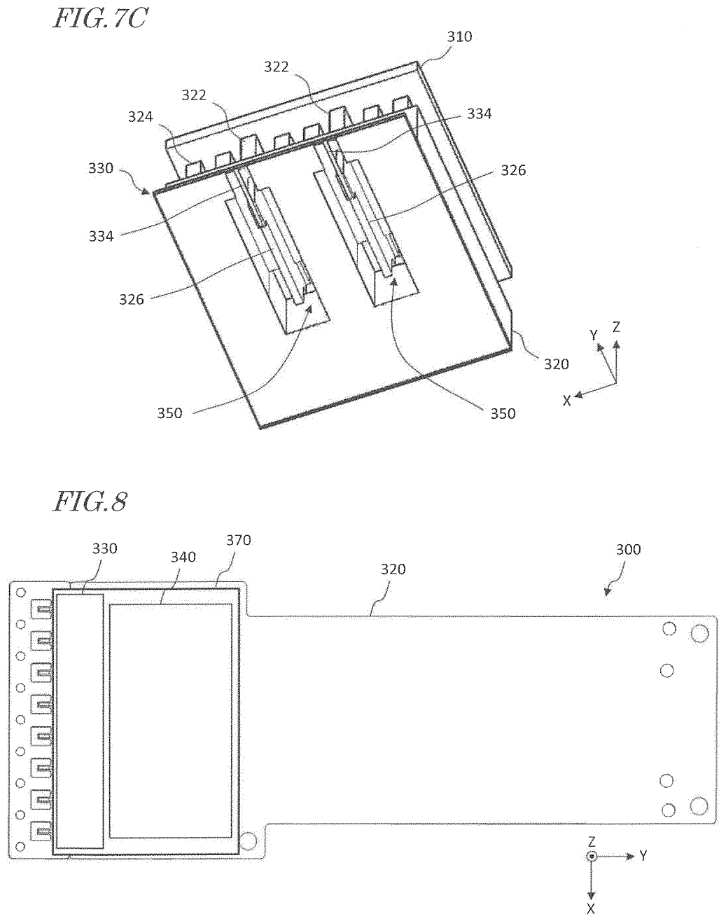

FIG. 7A is a perspective view showing the structure at the rear side of the waveguide device shown in FIG. 4A. FIG. 7B is a perspective view showing the waveguide device of FIG. 7A, with the MSL module 330 removed therefrom. FIG. 7C is a perspective view where, in the waveguide device shown in FIG. 7A, the dielectric substrate 331 and the first ground conductor 332 of the MSL module 330 are illustrated as if transparent.

As shown in FIG. 7B, the plurality of grooves 328 extending along the Y direction are located on the rear side of the second conductor 320, the plurality of grooves 328 presenting rectangular solid shapes. Inside the plurality of grooves 328, the plurality of ridge-shaped waveguides 326 are respectively located. One end of each waveguide 326 extends into the through hole 352, and is connected to one end of the waveguide 322 on the front side. Each groove 328 functions as a hollow waveguide (third waveguide), and allows an electromagnetic wave to be transmitted along the waveguide 326. Each waveguide 326 includes a protrusion 326b at an end that is closer to the opening of the groove 328. The top surface of the protrusion 326b is flat, and as shown in FIG. 7C, is in contact with the strip conductor 334 of the MSL module 330.

Each strip conductor 334 is connected to a microwave integrated circuit. The microwave integrated circuit is a chip or package of a semiconductor integrated circuit that generates or processes a radio frequency signal in the microwave band. A “package” is a package that includes one or more semiconductor integrated circuit chips that generates or processes a radio frequency signal in the microwave band. An IC having one or more microwave ICs being integrated on a single semiconductor substrate, in particular, is referred to as a “monolithic microwave integrated circuit” (MMIC). Although the present disclosure mainly describes an example of using an “MMIC” as a “microwave IC”, the microwave IC is not limited to an MMIC. In an example embodiment of the present disclosure, other types of microwave ICs may be used instead of an MMIC.

A “microwave” means an electromagnetic wave whose frequency is in the range from 300 MHz to 300 GHz. Among “microwaves”, electromagnetic waves whose frequency is in the range from 30 GHz to 300 GHz are called “millimeter waves”. The wavelength of a “microwave” in a vacuum is in the range from 1 mm to 1 m, whereas the wavelength of a “millimeter wave” is in the range from 1 mm to 10 mm. Moreover, an electromagnetic wave whose wavelength is in the range from 10 mm to 30 mm may be referred to as a “quasi-millimeter wave”.

A signal wave of a radio frequency that is generated by the microwave IC is consecutively transmitted to the waveguide 326 on the rear side and to the waveguide 322 on the front side, via the strip conductor 334. During reception, a signal wave that has propagated along the waveguide 322 is consecutively transmitted to the waveguide 326 on the rear side and to the strip conductor 334, thus reaching the microwave IC.

FIG. 8 is a diagram showing an exemplary construction in which an IC-mounted substrate 370 is disposed on the rear side of the antenna device 300. The IC-mounted substrate 370 includes the MSL module 330 and a microwave IC 340. The microwave IC 340 include a plurality of antenna input/output terminals. The plurality of antenna input/output terminals are respectively electrically connected to the plurality of strip conductors 334 of the MSL module 330.

The microwave IC 340 is adapted so as to generate or process radio frequency signals. The frequency band of radio frequency signals to be generated by the microwave IC 340 may be a band of about 28 GHz which is used in 5G communications, for example, but is not limited thereto. The microwave IC 340 functions as at least one of a transmitter and a receiver. The IC-mounted substrate 370 may include one or both of an A/D converter that is connected to a transmitter and a D/A converter that is connected to a receiver. The IC-mounted substrate 370 may further include a signal processing circuit that is connected to one or both of an A/D converter and a D/A converter. The signal processing circuit performs at least one of encoding of digital signals and decoding of digital signals. Such a signal processing circuit may be provided externally to the antenna device 300. For example, the communication device 500 shown in FIG. 1 may include one signal processing circuit for a plurality of antenna devices 300. Such a signal processing circuit will generate a signal to be transmitted by each antenna device 300, or process a signal received by each antenna device 300.

Next, the construction of the radiating section shown in FIG. 2 will be described in more detail.

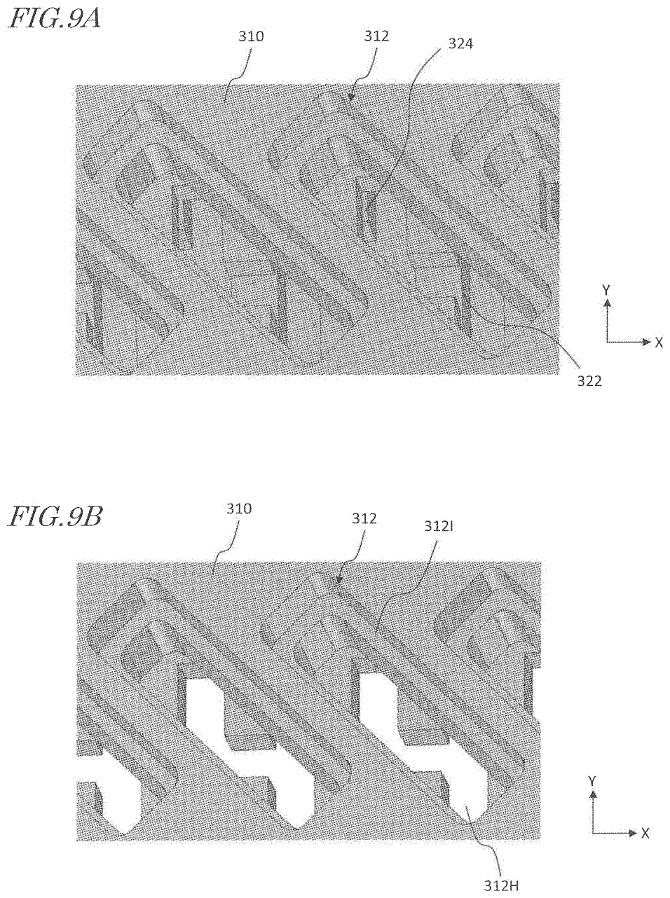

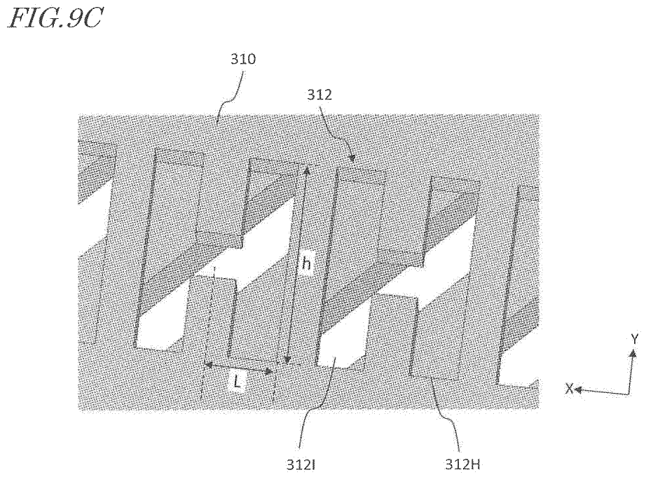

FIG. 9A is a diagram showing enlarged a portion of the radiating section of the first conductor 310 shown in FIG. 2. FIG. 9A shows a plurality of slot antenna elements 312 extending obliquely with respect to the Y direction, along which the waveguide 322 extends. Through the slot antenna elements 312, the plurality of waveguides 322 (as part of the second conductor 320 disposed on the rear side of the radiating section) and the plurality of conductive rods 324 are visible.

FIG. 9B is a diagram showing the device of FIG. 9A with the second conductor 320 removed therefrom, i.e., showing the radiating section of the first conductor 310 alone. Each of the plurality of slot antenna elements 312 in the radiating section has an I-shaped slot 312I on the front side that extends obliquely with respect to the Y direction, and an H-shaped slot 312H on the rear side that is continuous with the I-shaped slot 312I. As shown in FIG. 9A and FIG. 9B, when the slot antenna element 312 is viewed from the front side, only a portion of the H-shaped slot 312H is visible.

FIG. 9C is a diagram showing the radiating section of the first conductor 310 as viewed from the rear side. As viewed from the rear side, each H-shaped slot 312H, and a portion of the I-shaped slot 312I that is continuous with the H-shaped slot 312H are visible. The H-shaped slot 312H includes a lateral portion extending along the X direction and a pair of vertical portions which extend along the Y direction and which are continuous with opposite ends of the lateral portion. The central portion of the lateral portion of each H-shaped slot 312H is disposed so as to overlap the waveguide 322 when viewed from the Z direction. A gap exists between the waveguide surface of the waveguide 322 and the H-shaped slot 312H. With such construction, when an electromagnetic wave propagates along the waveguide surface of the waveguide 322, a portion of the electromagnetic wave that has been propagated is taken into the H-shaped slot 312H. Then, this electromagnetic wave is passed onto the I-shaped slot 312I extending obliquely with respect to the Y direction, so as to be radiated into the external space. With such construction, an electromagnetic wave having an electric field which is in an inclined direction with respect to the direction that the waveguide 322 extends can be radiated. Through an opposite process, an electromagnetic wave having an electric field in an oblique direction can also be received. In this example, the angle of inclination of the I-shaped slot 312I with respect to the direction that the waveguide 322 extends is 45 degrees; however, this angle may be any angle other than 45 degrees. Moreover, the I-shaped slot 312I may be omitted. In a construction lacking the I-shaped slot 312I, radiation or reception of an electromagnetic wave having a field component in the Y direction is possible.

In the example shown in FIG. 9C, a plurality of H-shaped slots 312H are arranged side by side along the X direction, so that their vertical portions are adjacent to one another. The length h of a vertical portion of each H-shaped slot 312H is longer than the distance L from the center of the lateral portion of the H-shaped slot to the outer edge of the vertical portion. With such construction, the interval between adjacent H-shaped slots 312H can be reduced. Moreover, in this example, more than half of the opening of the H-shaped slot 312H is closed at the obliquely-extending I-shaped slot 312I. Such structure however is not detrimental to the transmission and reception of electromagnetic waves.

Thus, in the present example embodiment, the second conductor 320 includes the conductive walls 354, each of which extends around one end of the waveguide 322 and around the through hole 352. The first conductor 310 has a slit 313 or recess 314 that accommodates at least a portion (e.g., a leading end) of the conductive wall 354. A first waveguide (WRG) is defined between the waveguide surface of the waveguide 322 and the first conductive surface 310b. Inward of the conductive wall 354, and inside the through hole 352, a second waveguide (hollow waveguide) to be connected to the first waveguide is defined. With such construction, a connection structure between a WRG and a hollow waveguide can be realized which is easy to produce and which has good characteristics.

Next, a variant of the present example embodiment will be described.

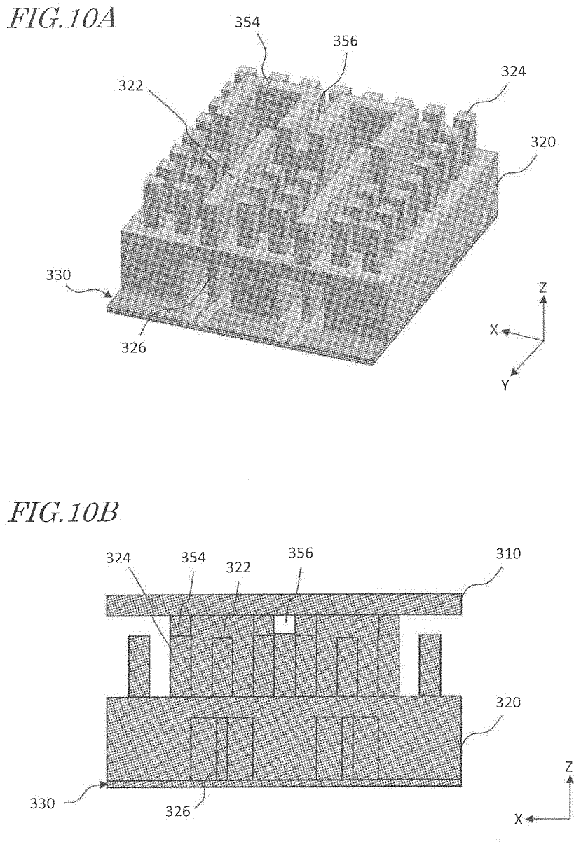

FIG. 10A is a diagram showing a variant of the waveguide device in FIG. 4A. The first conductor 310 is omitted from illustration in FIG. 10A. The waveguide device of this variant also includes a first conductor 310 as shown in FIG. 6A and FIG. 6B. FIG. 10B is a diagram showing the waveguide device of this variant as viewed from the +Y direction. In this example, two adjacent conductive walls 354 are continuous with each other. In other words, the two adjacent conductive walls 354 include a common portion that is located at one end of each of the two adjacent waveguides 322. However, at the top of the common portion, a groove 356 exists which extends along the direction that the two waveguides 322 extend, whereby the leading end of the waveguiding wall 354 is divided into two portions. As shown in FIG. 10B, the bottom face of the groove 356 is not in contact with the first conductor 310. With such structure, the portion at which the two adjacent conductive walls 354 are continuous has an increased thickness, which permits an easier melt flow during production by a method such as die-casting, thus facilitating the production. Even in the case of cutting, there is no need to machine out a deep groove between the adjacent conductive walls 354, thus allowing for an improved producibility.

### Second Example Embodiment

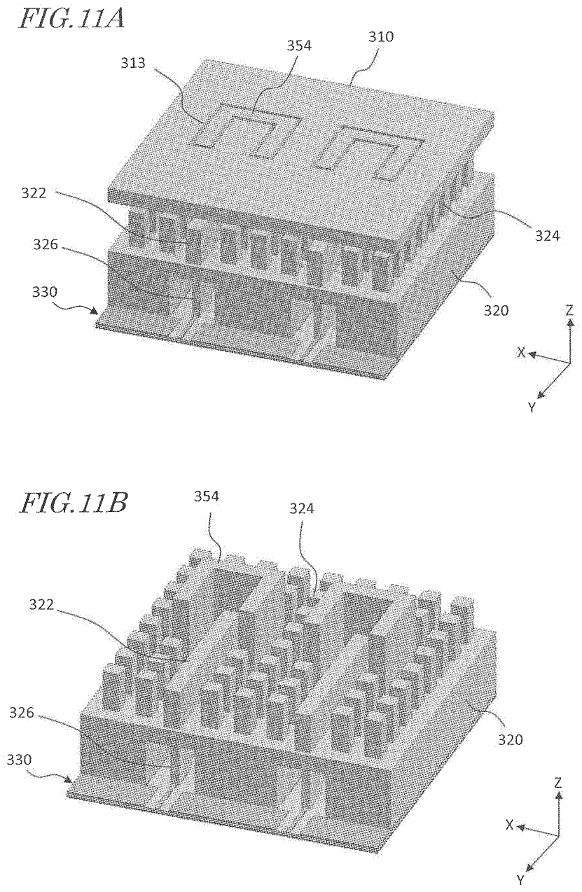

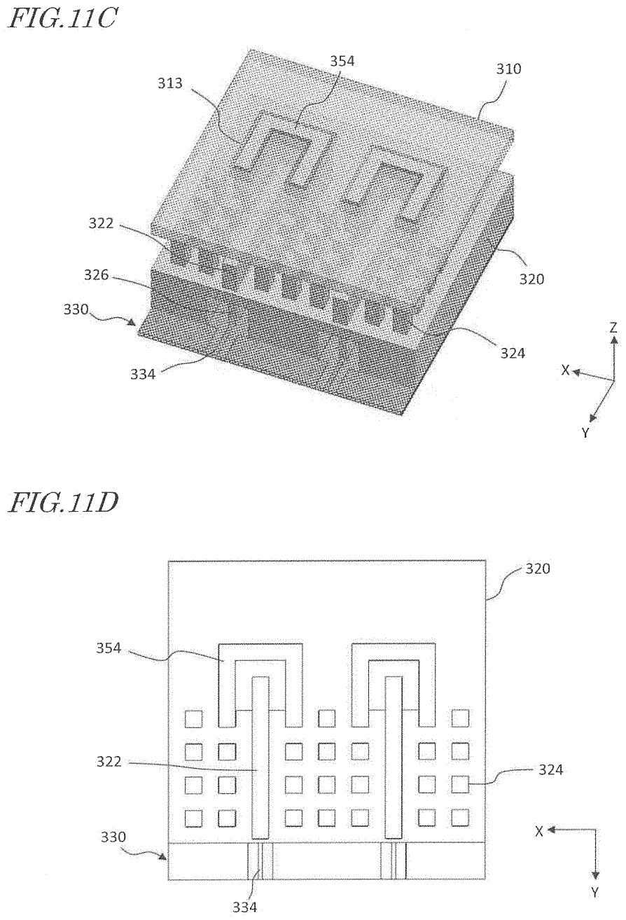

FIG. 11A is a perspective view showing a waveguide device according to an illustrative second example embodiment of the present disclosure. FIG. 11B is a perspective view showing the waveguide device of FIG. 11A, with the first conductor 310 removed therefrom. In the present example embodiment, between two adjacent conductive walls 354, a row of conductive rods 124 is disposed. Between two adjacent waveguides 322, three rows of conductive rods 124 are disposed. Such construction improves the isolation between signal waves propagating in two WRGs that are created along the two adjacent waveguides 322.

Note that the number of rows of conductive rods 324 between two adjacent conductive walls 354 is not limited to one, but may be two or more.

FIG. 11C is a diagram showing a variant of the present example embodiment. In FIG. 11C, the first conductor 310 is illustrated as if translucent, for ease of understanding the structure of the second conductor 320. FIG. 11D is a plan view showing the waveguide device according to this variant, with the first conductor 310 removed therefrom. This variant is based on the construction illustrated in FIGS. 11A and 11B, with the conductive rods 324 between and around two adjacent conductive walls 354 along the X direction being removed therefrom. As illustrated by this example, the conductive rods around each conductive wall 354 may be omitted. A similar structure is also applicable to other example embodiments of the present disclosure.

### Third Example Embodiment

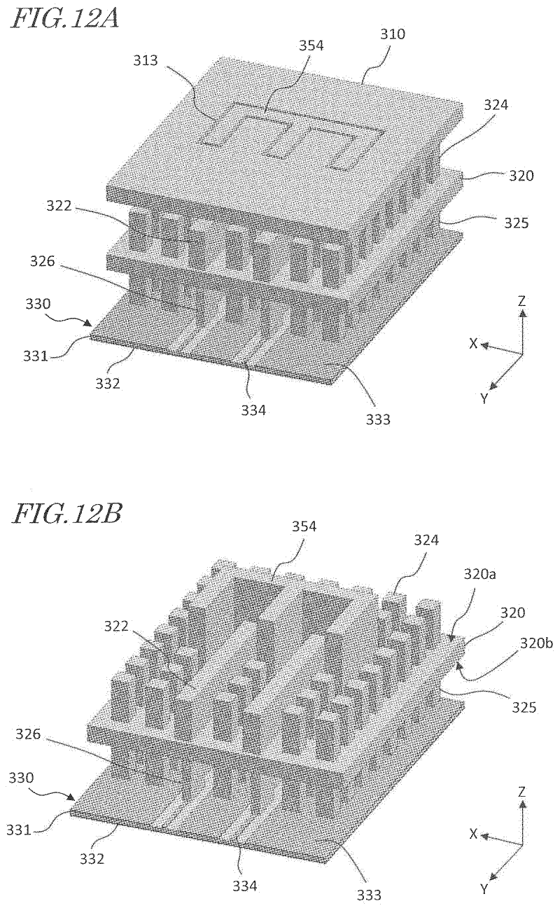

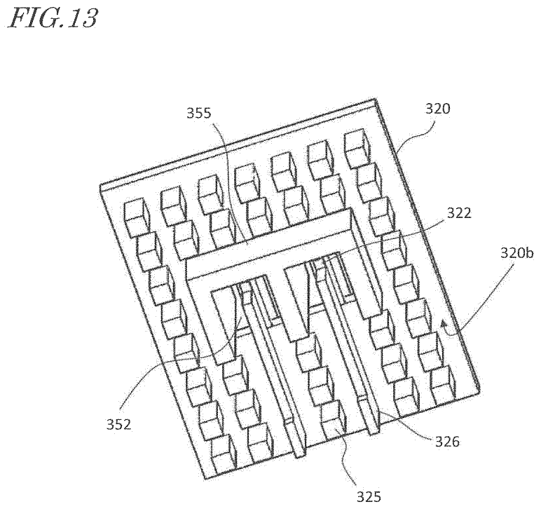

FIG. 12A is a perspective view showing a waveguide device according to an illustrative third example embodiment of the present disclosure. FIG. 12B is a perspective view showing the waveguide device of FIG. 12A, with the first conductor 310 removed therefrom. In the present example embodiment, two adjacent conductive walls 354 are continuous as one, such that an E-shaped conductive wall 354 is constituted as a whole. In the present disclosure, such construction is also encompassed within the notion of providing a plurality of conductive walls 354 such that each partially surrounds one end of a corresponding one of the plurality of waveguides 322.

In the example embodiments illustrated in FIG. 4A through FIG. 11D, the third waveguide which is created along each waveguide 326 on the rear side of the second conductor 320 is a hollow waveguide. On the other hand, in the present example embodiment, a WRG is created as a third waveguide along each waveguide 326 on the rear side. The second conductor 320 according to the present example embodiment includes a plurality of conductive rods 325 (second conductive rods) protruding from the third conductive surface 320b on the rear side. The conductive rods 325 are disposed around and between the plurality of waveguides 326 on the rear side. As the conductive rods 325 function as an artificial magnetic conductor, WRGs are created also on the rear side of the second conductor 320.

In the present example embodiment, the second ground conductor 333 (fourth conductive surface) of the MSL module 330 (third conductor) is opposed to the conductive surface 320b (third conductive surface) of the second conductor 320. The leading end of each conductive rod 325 on the rear side is opposed to the second ground conductor 333. A portion of the top surface of each waveguide 326 on the rear side is in contact with the strip conductor 334, while another portion of the top surface is opposed to the dielectric substrate 331. Since the first ground conductor 332 is located on the rear side of the dielectric substrate 331, the portion of the top surface is opposed to the first ground conductor 332 with the dielectric substrate 331 interposed therebetween. Moreover, the first ground conductor 332 and the second ground conductor 333 are connected by way of a via not shown. With such structure, an electromagnetic wave can be propagated along each waveguide 326 on the rear side.

FIG. 13 is a diagram showing the structure at the rear side of the second conductor 320 according to the present example embodiment. The second conductor 320 in the present example embodiment includes an E-shaped conductive wall 355 (second conductive wall) on the rear side as well. The inner surface of the conductive wall 355 on the rear side surrounds, partially (i.e., on three sides), each of the two through holes 352 in the second conductor 320. The top surface of each conductive wall 355 is in contact with the MSL module 330 (third conductor) via the second ground conductor 333 of the MSL module 330. One end of each waveguide 326 on the rear side extends into the through hole 352, so as to be continuous with one end of the waveguide 322 on the front side within the through hole 352. Such structure connects: a WRG that is created along the waveguide 326 on the rear side; a hollow waveguide that is created in a region surrounded by the conductive wall 355 on the rear side, the through hole 352, and the conductive wall 354 on the front side; and a WRG that is created along the waveguide 322 on the front side. As a result, similarly to each of the above-described example embodiments, signal waves can be transmitted between the microwave IC and each slot antenna element 312.

### Fourth Example Embodiment

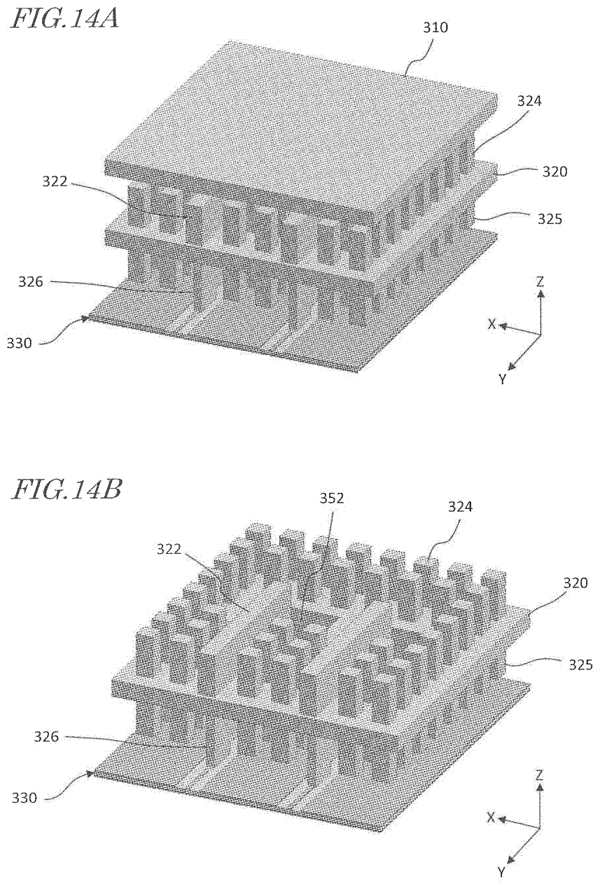

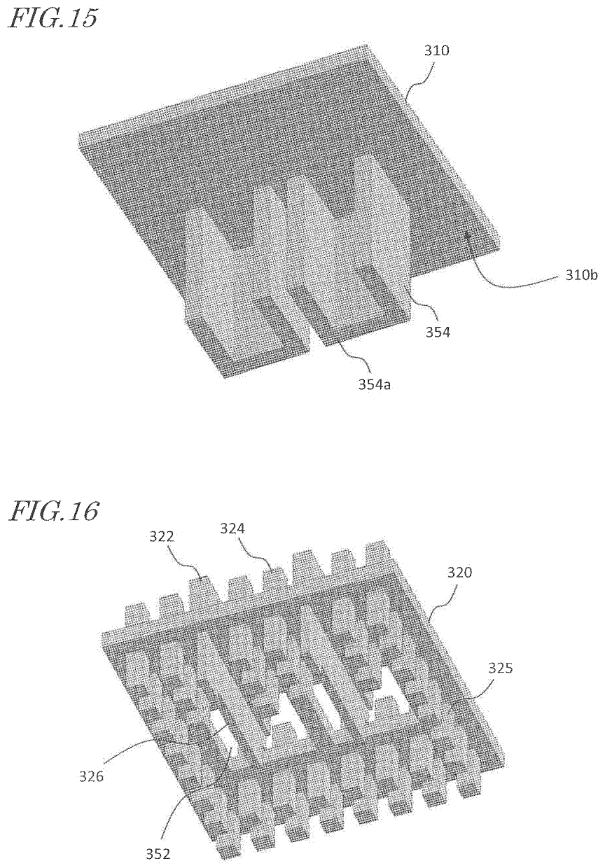

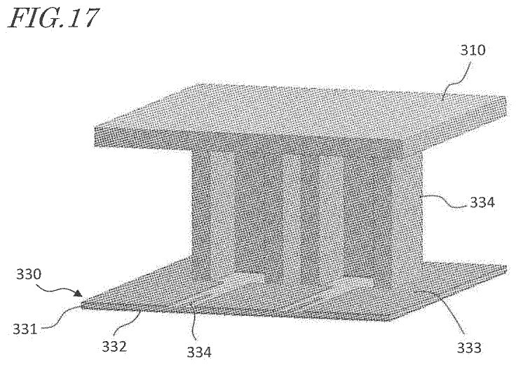

FIG. 14A is a perspective view showing a waveguide device according to an illustrative fourth example embodiment of the present disclosure. FIG. 14B is a perspective view showing the waveguide device of FIG. 14A, with the first conductor 310 removed therefrom. FIG. 15 is a diagram showing the first conductor 310 as viewed from the rear side. FIG. 16 is a diagram showing the second conductor 320 as viewed from the rear side.

In the present example embodiment, the conductive walls 354 are part of the first conductor 310. In other words, in the case where the production is carried out via molding such as die-casting, the conductive walls 354 and other portions composing the first conductor 310 can be produced as a continuous piece. The conductive walls 354 are accommodated in the through holes 352 of the second conductor 320. An end surface 354a of each conductive wall 354 is flat, and has a U shape. The end surface of each conductive wall 354 may be any other shape, such as an E shape as shown in FIG. 13, a C shape, etc.

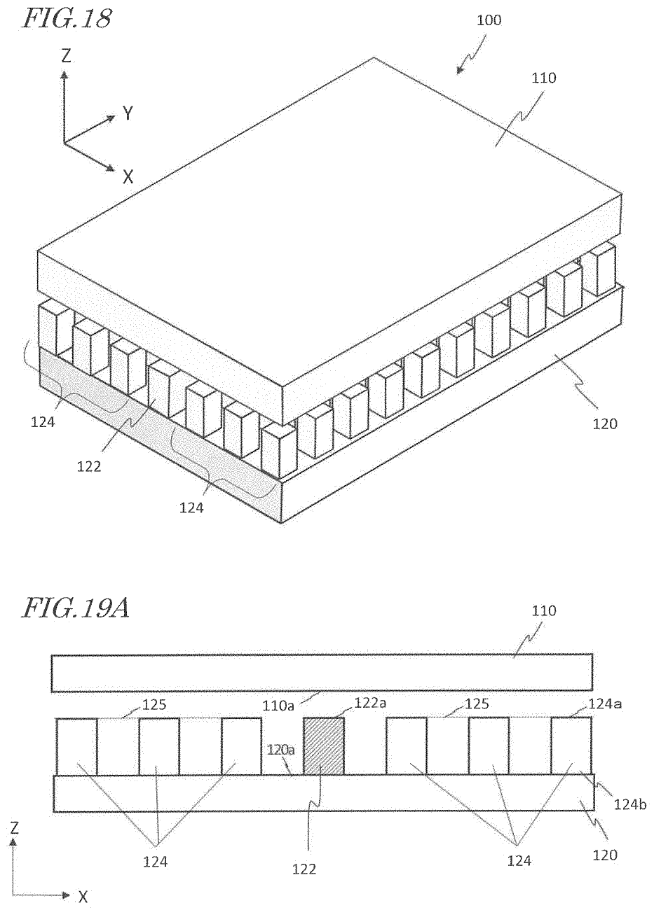

FIG. 17 is a diagram showing the waveguide device in FIG. 14A, with the second conductor 320 being rendered invisible. The end surfaces 354a of the conductive walls 354 are in contact with the second ground conductor 333 of the MSL module 330.

As in the third example embodiment, such structure connects: a WRG that is created along the waveguide 326 on the rear side; a hollow waveguide that is created in a region that is partially surrounded by the conductive wall 355; and a WRG that is created along the waveguide 322 on the front side. As a result, as in each of the above-described example embodiments, signal waves can be transmitted between the microwave IC and each slot antenna element 312.

Note that the second conductor 320 according to the present example embodiment may have a similar structure to that of the second conductor 320 of the first or second example embodiment. In other words, the waveguides on the rear side of the second conductor 320 may be constituted by hollow waveguides, rather than WRGs.

In the first to fourth example embodiments above, the MSL module 330 is disposed as a third conductor on the rear side of the second conductor 320; however, the present disclosure is not limited to such example embodiments. Instead of the MSL module 330, a conductor lacking microstrip lines may be disposed as a third conductor.

### Exemplary WRG Construction

Next, an exemplary construction of a WRG that is used in an example embodiment of the present disclosure above will be described in more detail. A WRG is a ridge waveguide that may be provided in a waffle iron structure functioning as an artificial magnetic conductor. Such a ridge waveguide is able to realize an antenna feeding network with low losses in the microwave or the millimeter wave band. Moreover, use of such a ridge waveguide allows antenna elements to be disposed with a high density. Hereinafter, an exemplary fundamental construction and operation of such a waveguide structure will be described.

An artificial magnetic conductor is a structure which artificially realizes the properties of a perfect magnetic conductor (PMC), which does not exist in nature. One property of a perfect magnetic conductor is that “a magnetic field on its surface has zero tangential component”. This property is the opposite of the property of a perfect electric conductor (PEC), i.e., “an electric field on its surface has zero tangential component”. Although no perfect magnetic conductor exists in nature, it can be embodied by an artificial structure, e.g., an array of a plurality of electrically conductive rods. An artificial magnetic conductor functions as a perfect magnetic conductor in a specific frequency band which is defined by its structure. An artificial magnetic conductor restrains or prevents an electromagnetic wave of any frequency that is contained in the specific frequency band (propagation-restricted band) from propagating along the surface of the artificial magnetic conductor. For this reason, the surface of an artificial magnetic conductor may be referred to as a high impedance surface.

For example, a plurality of electrically conductive rods that are arranged along row and column directions may constitute an artificial magnetic conductor. Such rods may be referred to posts or pins. Each of these waveguide devices, as a whole, includes a pair of opposing electrically conductive plates. One of the electrically conductive plates has a ridge that protrudes toward the other electrically conductive plate, and an artificial magnetic conductor that are located on both sides of the ridge. Via a gap, an upper face (which is an electrically-conductive face) of the ridge is opposed to the electrically conductive surface of the other electrically conductive plate. An electromagnetic wave (signal wave) of a wavelength which is contained in the propagation stop band of the artificial magnetic conductor propagates along the ridge, in the space (gap) between this conductive surface and the upper face of the ridge.

FIG. 18 is a perspective view showing a non-limiting example of a fundamental construction of such a waveguide device. The waveguide device 100 shown in the figure includes a plate shape (plate-like) electrical conductors 110 and 120, which are in opposing and parallel positions to each other. A plurality of electrically conductive rods 124 are arrayed on the conductor 120.

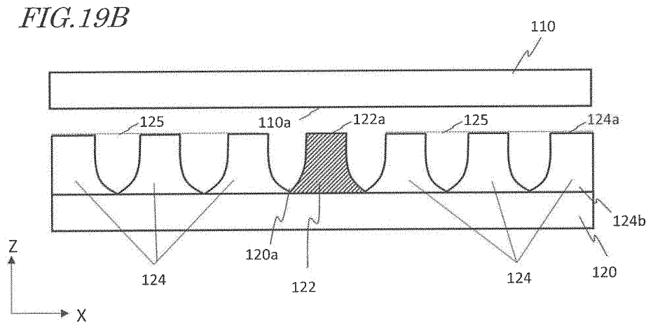

FIG. 19A is a diagram schematically showing a cross-sectional construction of the waveguide device 100 as taken parallel to the XZ plane. As shown in FIG. 19A, the conductor 110 has an electrically conductive surface 110a on the side facing the conductor 120. The conductive surface 110a has a two-dimensional expanse along a plane which is orthogonal to the axial direction (i.e., the Z direction) of the conductive rods 124 (i.e., a plane which is parallel to the XY plane). Although the conductive surface 110a is shown to be a smooth plane in this example, the conductive surface 110a does not need to be a plane, as will be described later.

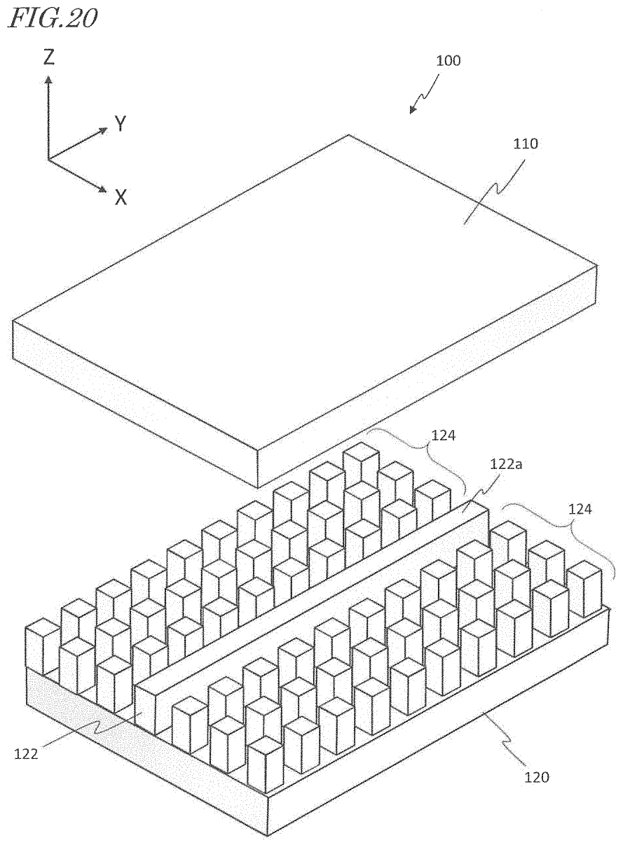

FIG. 20 is a perspective view schematically showing the waveguide device 100, illustrated so that the spacing between the conductor 110 and the conductor 120 is exaggerated for ease of understanding. In an actual waveguide device 100, as shown in FIG. 18 and FIG. 19A, the spacing between the conductor 110 and the conductor 120 is narrow, with the conductor 110 covering over all of the conductive rods 124 on the conductor 120.

FIG. 18 to FIG. 20 only show portions of the waveguide device 100. The conductors 110 and 120, the waveguide 122, and the plurality of conductive rods 124 actually extend to outside of the portions illustrated in the figures. At an end of the waveguide 122, a choke structure for preventing electromagnetic waves from leaking into the external space is provided. The choke structure may include a row of conductive rods that are adjacent to the end of the waveguide 122, for example.

See FIG. 19A again. The plurality of conductive rods 124 arrayed on the conductor 120 each have a leading end 124a opposing the conductive surface 110a. In the example shown in the figure, the leading ends 124a of the plurality of conductive rods 124 are on the same plane or on substantially the same plane. This plane defines the surface 125 of an artificial magnetic conductor. Each conductive rod 124 does not need to be entirely electrically conductive, so long as it includes an electrically conductive layer which extends at least along the upper face and the side faces of the rod-like structure. This electrically conductive layer may be located on the surface layer of the rod-like structure; alternatively, the surface layer may be composed of insulation coating or a resin layer, with no electrically conductive layer being present on the surface of the rod-like structure. Moreover, each conductor 120 does not need to be entirely electrically conductive, so long as it can support the plurality of conductive rods 124 to constitute an artificial magnetic conductor. Of the surfaces of the conductor 120, a face carrying the plurality of conductive rods 124 may be electrically conductive, such that the electrical conductor electrically interconnects the surfaces of adjacent ones of the plurality of conductive rods 124. The electrically conductive layer of the conductor 120 may be covered with insulation coating or a resin layer. In other words, the entire combination of the conductor 120 and the plurality of conductive rods 124 may at least include an electrically conductive layer with rises and falls opposing the conductive surface 110a of the conductor 110.

On the conductor 120, a ridge-like waveguide 122 is provided among the plurality of conductive rods 124. More specifically, stretches of an artificial magnetic conductor are present on both sides of the waveguide 122, such that the waveguide 122 is sandwiched between the stretches of artificial magnetic conductor on both sides. As can be seen from FIG. 20, the waveguide 122 in this example is supported on the conductor 120, and extends linearly along the Y direction. In the example shown in the figure, the waveguide 122 has the same height and width as those of the conductive rods 124. As will be described later, however, the height and width of the waveguide 122 may have respectively different values from those of the conductive rod 124. Unlike the conductive rods 124, the waveguide 122 extends along a direction (which in this example is the Y direction) in which to guide electromagnetic waves along the conductive surface 110a. Similarly, the waveguide 122 does not need to be entirely electrically conductive, but may at least include an electrically conductive waveguide surface 122a opposing the conductive surface 110a of the conductor 110. The conductor 120, the plurality of conductive rods 124, and the waveguide 122 may be portions of a continuous single-piece body. Furthermore, the conductor 110 may also be a portion of such a single-piece body.

On both sides of the waveguide 122, the space between the surface 125 of each stretch of artificial magnetic conductor and the conductive surface 110a of the conductor 110 does not allow an electromagnetic wave of any frequency that is within a specific frequency band to propagate. This frequency band is called a “prohibited band”. The artificial magnetic conductor is designed so that the frequency of an electromagnetic wave (signal wave) to propagate in the waveguide device 100 (which may hereinafter be referred to as the “operating frequency”) is contained in the prohibited band. The prohibited band may be adjusted based on the following: the height of the conductive rods 124, i.e., the depth of each groove formed between adjacent conductive rods 124; the diameter of each conductive rod 124; the interval between conductive rods 124; and the size of the gap between the leading end 124a and the conductive surface 110a of each conductive rod 124.

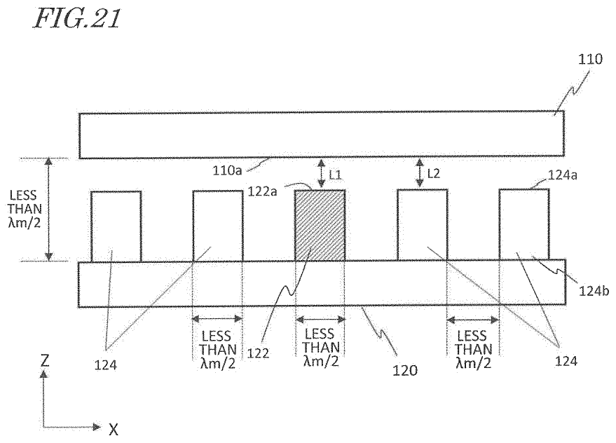

Next, with reference to FIG. 21, the dimensions, shape, positioning, and the like of each member will be described.

FIG. 21 is a diagram showing an exemplary range of dimension of each member in the structure shown in FIG. 19A. The waveguide device is used for at least one of transmission and reception of electromagnetic waves of a predetermined band (referred to as the “operating frequency band”). In the present specification, λo denotes a representative value of wavelengths in free space (e.g., a central wavelength corresponding to a center frequency in the operating frequency band) of an electromagnetic wave (signal wave) propagating in a waveguide extending between the conductive surface 110a of the conductor 110 and the waveguide surface 122a of the waveguide 122. Moreover, λm denotes a wave-length, in free space, of an electromagnetic wave of the highest frequency in the operating frequency band. The end of each conductive rod 124 that is in contact with the conductor 120 is referred to as the “root”. As shown in FIG. 21, each conductive rod 124 has the leading end 124a and the root 124b. Examples of dimensions, shapes, positioning, and the like of the respective members are as follows.

### (1) Width of the Conductive Rod

The width (i.e., the size along the X direction and the Y direction) of the conductive rod 124 may be set to less than λm/2. Within this range, resonance of the lowest order can be prevented from occurring along the X direction and the Y direction. Since resonance may possibly occur not only in the X and Y directions but also in any diagonal direction in an X-Y cross section, the diagonal length of an X-Y cross section of the conductive rod 124 is also preferably less than λm/2. The lower limit values for the rod width and diagonal length will conform to the minimum lengths that are producible under the given manufacturing method, but is not particularly limited.

### (2) Distance From the Root of the Conductive Rod to the Conductive Surface of the Conductor 110

The distance from the root 124b of each conductive rod 124 to the conductive surface 110a of the conductor 110 may be longer than the height of the conductive rods 124, while also being less than λm/2. When the distance is λm/2 or more, resonance may occur between the root 124b of each conductive rod 124 and the conductive surface 110a, thus reducing the effect of signal wave containment.

The distance from the root 124b of each conductive rod 124 to the conductive surface 110a of the conductor 110 corresponds to the spacing between the conductor 110 and the conductor 120. For example, when a signal wave of 76.5±0.5 GHz (which belongs to the millimeter band or the extremely high frequency band) propagates in the waveguide, the wavelength of the signal wave is in the range from 3.8934 mm to 3.9446 mm. Therefore, λm equals 3.8934 mm in this case, so that the spacing between the conductor 110 and the conductor 120 may be designed to be less than a half of 3.8934 mm. So long as the conductor 110 and the conductor 120 realize such a narrow spacing while being disposed opposite from each other, the conductor 110 and the conductor 120 do not need to be strictly parallel. Moreover, when the spacing between the conductor 110 and the conductor 120 is less than λm/2, a whole or a part of the conductor 110 and/or the conductor 120 may be shaped as a curved surface. On the other hand, the conductors 110 and 120 each have a planar shape (i.e., the shape of their region as perpendicularly projected onto the XY plane) and a planar size (i.e., the size of their region as perpendicularly projected onto the XY plane) which may be arbitrarily designed depending on the purpose.

In the example shown in FIG. 19A, the conductive surface 120a is illustrated as a plane; however, example embodiments of the present disclosure are not limited thereto. For example, as shown in FIG. 19B, the conductive surface 120a may be the bottom parts of faces each of which has a cross section similar to a U-shape or a V-shape. The conductive surface 120a will have such a structure when each conductive rod 124 or the waveguide 122 is shaped with a width which increases toward the root. Even with such a structure, the device shown in FIG. 19B can function as the waveguide device according to an example embodiment of the present disclosure so long as the distance between the conductive surface 110a and the conductive surface 120a is less than a half of the wavelength λm.

### (3) Distance L2 From the Leading End of the Conductive Rod to the Conductive Surface

The distance L2 from the leading end 124a of each conductive rod 124 to the conductive surface 110a is set to less than λm/2. When the distance is λm/2 or more, a propagation mode where electromagnetic waves reciprocate between the leading end 124a of each conductive rod 124 and the conductive surface 110a may occur, thus no longer being able to contain an electromagnetic wave. Note that, among the plurality of conductive rods 124, at least those which are adjacent to the waveguide 122 do not have their leading ends in electrical contact with the conductive surface 110a. As used herein, the leading end of a conductive rod not being in electrical contact with the conductive surface means either of the following states: there being an air gap between the leading end and the conductive surface; or the leading end of the conductive rod and the conductive surface adjoining each other via an insulating layer which may exist in the leading end of the conductive rod or in the conductive surface.

### (4) Arrangement and Shape of Conductive Rods

The interspace between two adjacent conductive rods 124 among the plurality of conductive rods 124 has a width of less than λm/2, for example. The width of the interspace between any two adjacent conductive rods 124 is defined by the shortest distance from the surface (side face) of one of the two conductive rods 124 to the surface (side face) of the other. This width of the interspace between rods is to be determined so that resonance of the lowest order will not occur in the regions between rods. The conditions under which resonance will occur are determined based by a combination of: the height of the conductive rods 124; the distance between any two adjacent conductive rods; and the capacitance of the air gap between the leading end 124a of each conductive rod 124 and the conductive surface 110a. Therefore, the width of the interspace between rods may be appropriately determined depending on other design parameters. Although there is no clear lower limit to the width of the interspace between rods, for manufacturing ease, it may be e.g. λm/16 or more when an electromagnetic wave in the extremely high frequency range is to be propagated. Note that the interspace does not need to have a constant width. So long as it remains less than λm/2, the interspace between conductive rods 124 may vary.

The arrangement of the plurality of conductive rods 124 is not limited to the illustrated example, so long as it exhibits a function of an artificial magnetic conductor. The plurality of conductive rods 124 do not need to be arranged in orthogonal rows and columns; the rows and columns may be intersecting at angles other than 90 degrees. The plurality of conductive rods 124 do not need to form a linear array along rows or columns, but may be in a dispersed arrangement which does not present any straight-forward regularity. The conductive rods 124 may also vary in shape and size depending on the position on the conductor 120.

The surface 125 of the artificial magnetic conductor that are constituted by the leading ends 124a of the plurality of conductive rods 124 does not need to be a strict plane, but may be a plane with minute rises and falls, or even a curved surface. In other words, the conductive rods 124 do not need to be of uniform height, but rather the conductive rods 124 may be diverse so long as the array of conductive rods 124 is able to function as an artificial magnetic conductor.

Each conductive rod 124 does not need to have a prismatic shape as shown in the figure, but may have a cylindrical shape, for example. Furthermore, each conductive rod 124 does not need to have a simple columnar shape. The artificial magnetic conductor may also be realized by any structure other than an array of conductive rods 124, and various artificial magnetic conductors are applicable to the waveguide device of the present disclosure. Note that, when the leading end 124a of each conductive rod 124 has a prismatic shape, its diagonal length is preferably less than λm/2. When the leading end 124a of each conductive rod 124 is shaped as an ellipse, the length of its major axis is preferably less than λm/2. Even when the leading end 124a has any other shape, the dimension across it is preferably less than λm/2 even at the longest position.

The height of each conductive rod 124 (in particular, those conductive rods 124 which are adjacent to the waveguide 122), i.e., the length from the root 124b to the leading end 124a, may be set to a value which is shorter than the distance (i.e., less than λm/2) between the conductive surface 110a and the conductive surface 120a, e.g., λo/4.

### (5) Width of the Waveguide Surface

The width of the waveguide surface 122a of the waveguide 122, i.e., the size of the waveguide surface 122a along a direction which is orthogonal to the direction that the waveguide 122 extends, may be set to less than λm/2 (e.g. λo/8). If the width of the waveguide surface 122a is λm/2 or more, resonance will occur along the width direction, which will prevent any WRG from operating as a simple transmission line.

### (6) Height of the Waveguide

The height (i.e., the size along the Z direction in the example shown in the figure) of the waveguide 122 is set to less than λm/2. The reason is that, if the distance is λm/2 or more, the distance between the root 124b of each conductive rod 124 and the conductive surface 110a will be λm/2 or more.

### (7) Distance L1 Between the Waveguide Surface and the Conductive Surface

The distance L1 between the waveguide surface 122a of the waveguide 122 and the conductive surface 110a is set to less than λm/2. If the distance is λm/2 or more, resonance will occur between the waveguide surface 122a and the conductive surface 110a, which will prevent functionality as a waveguide. In one example, the distance L1 is λm/4 or less. In order to ensure manufacturing ease, when an electromagnetic wave in the extremely high frequency range is to propagate, the distance L1 is preferably λm/16 or more, for example.

The lower limit of the distance L1 between the conductive surface 110a and the waveguide surface 122a and the lower limit of the distance L2 between the conductive surface 110a and the leading end 124a of each conductive rod 124 depends on the machining precision, and also on the precision when assembling the two upper/lower conductors 110 and 120 so as to be apart by a constant distance. When a pressing technique or an injection technique is used, the practical lower limit of the aforementioned distance is about 50 micrometers (μm). In the case of using MEMS (Micro-Electro-Mechanical System) technology to make a product in e.g. the terahertz range, the lower limit of the aforementioned distance is about 2 to about 3 μm.

Next, variants of waveguide structures including the waveguide 122, the conductors 110 and 120, and the plurality of conductive rods 124 will be described. The following variants are applicable to the WRG structure in any place in example embodiments of the present disclosure.

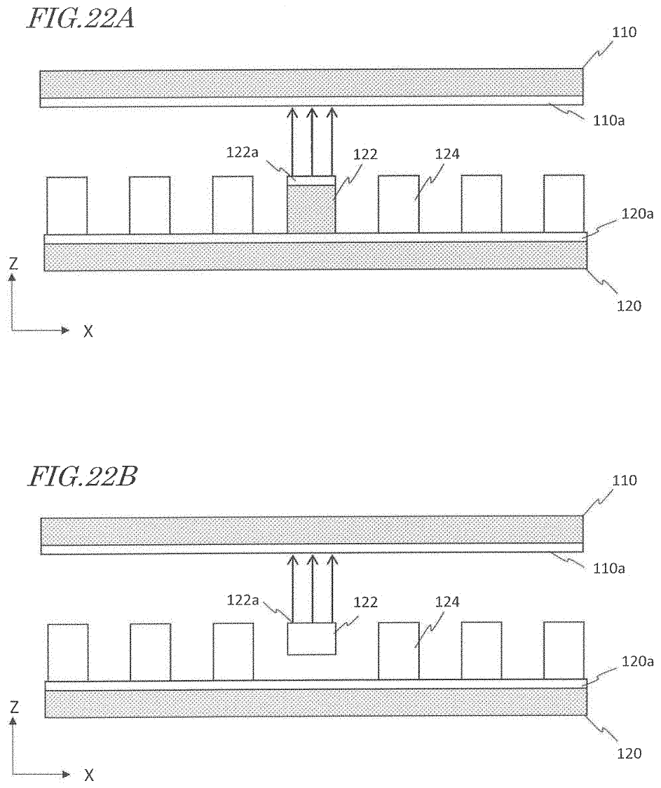

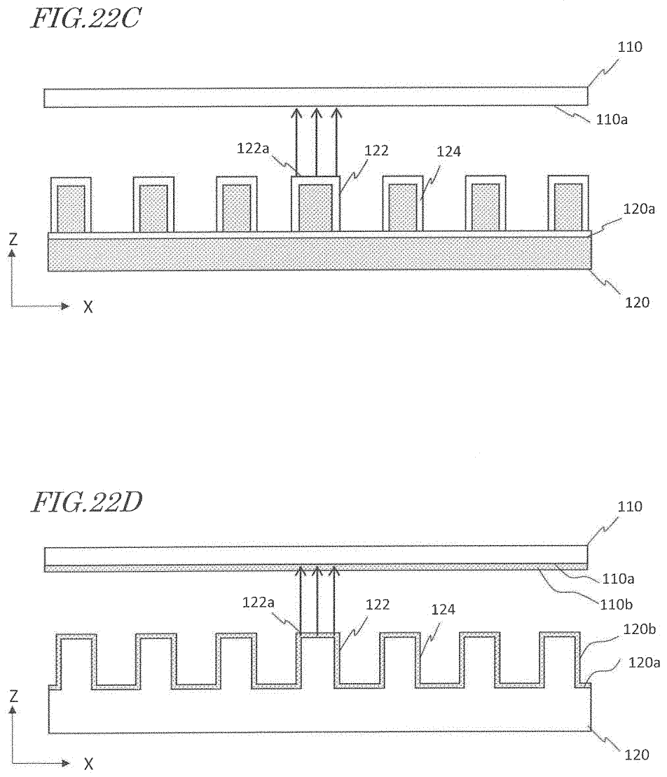

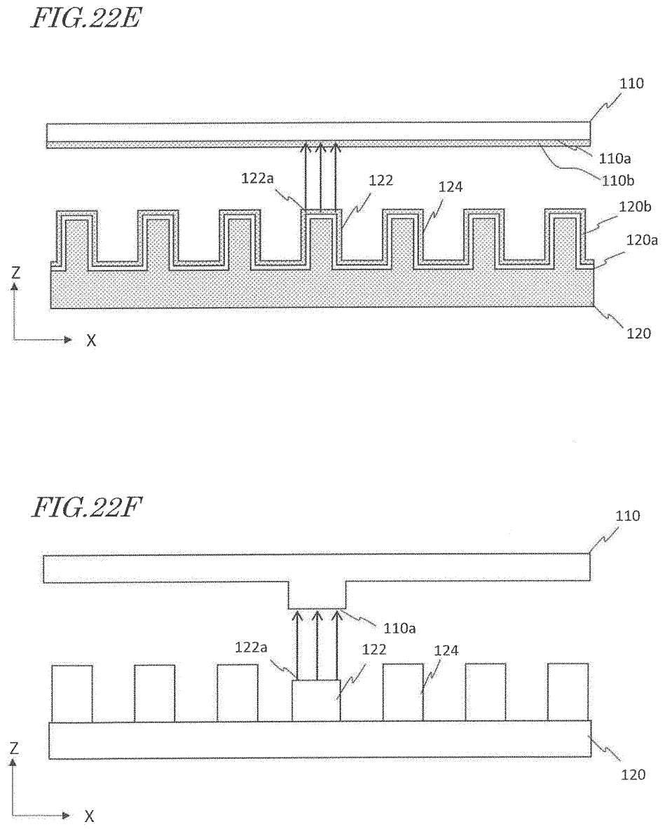

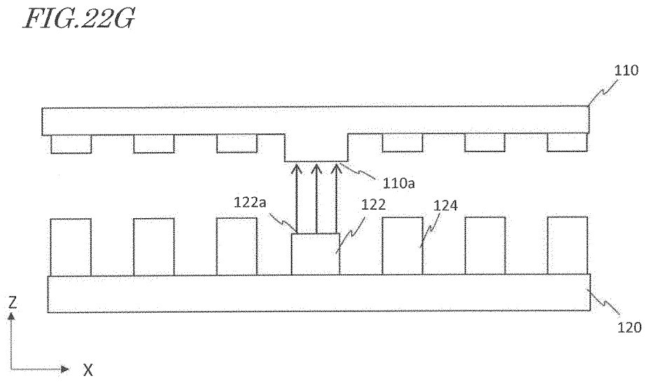

FIG. 22A is a cross-sectional view showing an exemplary structure in which only the waveguide surface 122a, defining an upper face of the waveguide 122, is electrically conductive, while any portion of the waveguide 122 other than the waveguide surface 122a is not electrically conductive. Both of the conductors 110 and 120 alike are only electrically conductive at their surface that has the waveguide 122 provided thereon (i.e., the conductive surface 110a, 120a), while not being electrically conductive in any other portions. Thus, each of the waveguide 122, the conductor 110, and the conductor 120 does not need to be electrically conductive.

FIG. 22B is a diagram showing a variant in which the waveguide 122 is not formed on the conductor 120. In this example, the waveguide 122 is fixed to a supporting member (e.g., the inner wall of the housing) that supports the conductors 110 and 120. A gap exists between the waveguide 122 and the conductor 120. Thus, the waveguide 122 does not need to be connected to the conductor 120.

FIG. 22C is a diagram showing an exemplary structure where the conductor 120, the waveguide 122, and each of the plurality of conductive rods 124 are composed of a dielectric surface that is coated with an electrically conductive material such as a metal. The conductor 120, the waveguide 122, and the plurality of conductive rods 124 are connected to one another via the electrical conductor. On the other hand, the conductor 110 is made of an electrically conductive material such as a metal.

FIG. 22D and FIG. 22E are diagrams each showing an exemplary structure in which dielectric layers 110b and 120b are respectively provided on the outermost surfaces of conductors 110 and 120, a waveguide 122, and conductive rods 124. FIG. 22D shows an exemplary structure in which the surface of metal conductors, which are electrical conductors, are covered with a dielectric layer. FIG. 22E shows an example where the conductor 120 is structured so that the surface of members which are composed of a dielectric, e.g., resin, is covered with an electrical conductor such as a metal, this metal layer being further coated with a dielectric layer. The dielectric layer that covers the metal surface may be a coating of resin or the like, or an oxide film of passivation coating or the like which is generated as the metal becomes oxidized.

The dielectric layer on the outermost surface will allow losses to be increased in the electromagnetic wave propagating through the WRG waveguide, but is able to protect the conductive surfaces 110a and 120a (which are electrically conductive) from corrosion. It also prevents influences of a DC voltage, or an AC voltage of such a low frequency that it is not capable of propagation on certain WRG waveguides.

FIG. 22F is a diagram showing an example where the height of the waveguide 122 is lower than the height of the conductive rods 124, and the portion of the conductive surface 110a of the conductor 110 that is opposed to the waveguide surface 122a protrudes toward the waveguide 122. Even such a structure will operate in a similar manner to the above-described example embodiment, so long as the ranges of dimensions depicted in FIG. 21 are satisfied.

FIG. 22G is a diagram showing an example where, further in the structure of FIG. 22F, portions of the conductive surface 110a that are opposed to the conductive rods 124 protrude toward the conductive rods 124. Even such a structure will operate in a similar manner to the above-described example embodiment, so long as the ranges of dimensions depicted in FIG. 21 are satisfied. Instead of a structure in which the conductive surface 110a partially protrudes, a structure in which the conductive surface 110a is partially dented may be adopted.

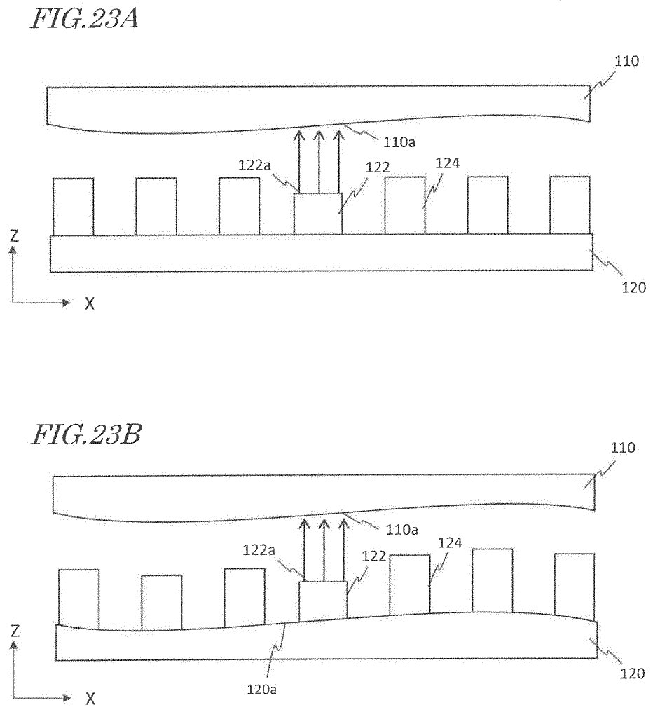

FIG. 23A is a diagram showing an example where a conductive surface 110a of the conductor 110 is shaped as a curved surface. FIG. 23B is a diagram showing an example where also a conductive surface 120a of the conductor 120 is shaped as a curved surface. As demonstrated by these examples, the conductive surfaces 110a and 120a may not be shaped as planes, but may be shaped as curved surfaces. A conductor having a conductive surface which is a curved surface is also qualifies as a conductor having a “plate shape”.

In the waveguide device 100 of the above-described construction, a signal wave of the operating frequency is unable to propagate in the space between the surface 125 of the artificial magnetic conductor and the conductive surface 110a of the conductor 110, but propagates in the space between the waveguide surface 122a of the waveguide 122 and the conductive surface 110a of the conductor 110. Unlike in a hollow waveguide, the width of the waveguide 122 in such a waveguide structure does not need to be equal to or greater than a half of the wavelength of the electro-magnetic wave to propagate. Moreover, the conductor 110 and the conductor 120 do not need to be electrically interconnected by a metal wall that extends along the thickness direction (i.e., in parallel to the YZ plane).

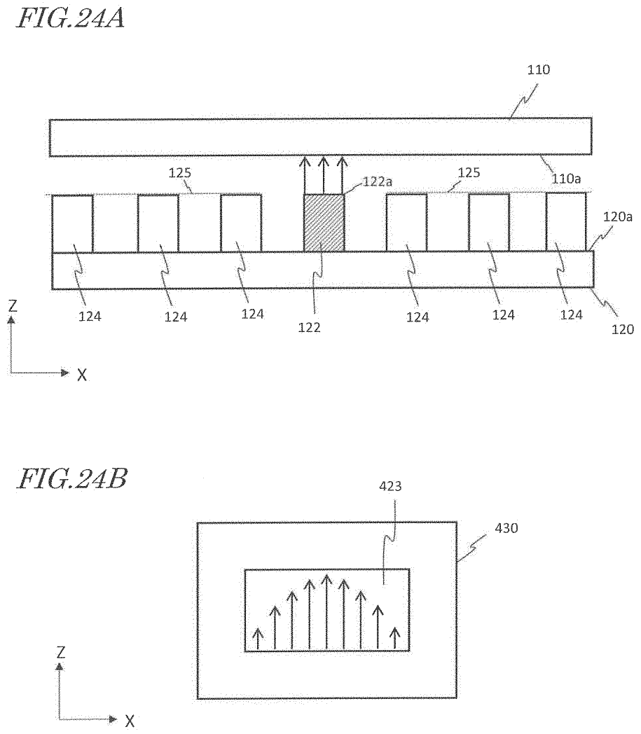

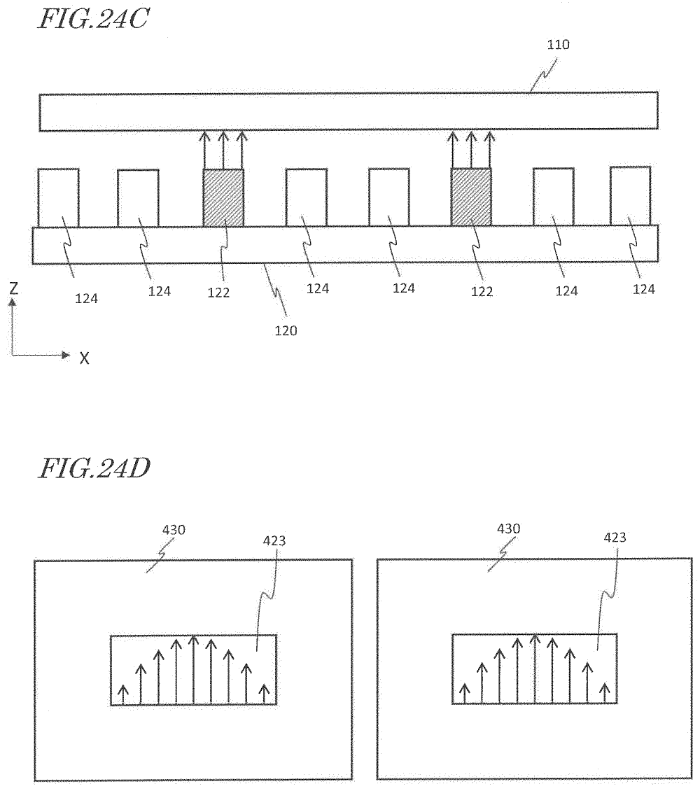

FIG. 24A schematically shows an electromagnetic wave that propagates in a narrow space, i.e., a gap between the waveguide surface 122a of the waveguide 122 and the conductive surface 110a of the conductor 110. Three arrows in FIG. 24A schematically indicate the orientation of an electric field of the propagating electromagnetic wave. The electric field of the propagating electromagnetic wave is perpendicular to the conductive surface 110a of the conductor 110 and to the waveguide surface 122a.

On both sides of the waveguide 122, stretches of artificial magnetic conductor that are created by the plurality of conductive rods 124 are present. An electromagnetic wave propagates in the gap between the waveguide surface 122a of the waveguide 122 and the conductive surface 110a of the conductor 110. FIG. 24A is schematic, and does not accurately represent the magnitude of an electromagnetic field to be actually created by the electromagnetic wave. A part of the electromagnetic wave (electromagnetic field) propagating in the space over the waveguide surface 122a may have a lateral expanse, to the outside (i.e., toward where the artificial magnetic conductor exists) of the space that is delineated by the width of the waveguide surface 122a. In this example, the electromagnetic wave propagates in a direction (i.e., the Y direction) which is perpendicular to the plane of FIG. 24A. As such, the waveguide 122 does not need to extend linearly along the Y direction, but may include a bend(s) and/or a branching portion(s) not shown. Since the electromagnetic wave propagates along the waveguide surface 122a of the waveguide 122, the direction of propagation would change at a bend, whereas the direction of propagation would ramify into plural directions at a branching portion.

In the waveguide structure of FIG. 24A, no metal wall (electric wall), which would be indispensable to a hollow waveguide, exists on both sides of the propagating electromagnetic wave. Therefore, in the waveguide structure of this example, “a constraint due to a metal wall (electric wall)” is not included in the boundary conditions for the electromagnetic field mode to be created by the propagating electromagnetic wave, and the width (size along the X direction) of the waveguide surface 122a is less than a half of the wavelength of the electromagnetic wave.

For reference, FIG. 24B schematically shows a cross section of a hollow waveguide 430. With arrows, FIG. 24B schematically shows the orientation of an electric field of an electromagnetic field mode (TE₁₀) that is created in the internal space 423 of the hollow waveguide 430. The lengths of the arrows correspond to electric field intensities. The width of the internal space 423 of the hollow waveguide 430 needs to be set to be broader than a half of the wavelength. In other words, the width of the internal space 423 of the hollow waveguide 430 cannot be set to be smaller than a half of the wavelength of the propagating electromagnetic wave.

FIG. 24C is a cross-sectional view showing an implementation where two waveguides 122 are provided on the conductor 120. Thus, an artificial magnetic conductor that is created by the plurality of conductive rods 124 exists between the two adjacent waveguides 122. More accurately, stretches of artificial magnetic conductor created by the plurality of conductive rods 124 are present on both sides of each waveguide 122, such that each waveguide 122 is able to independently propagate an electromagnetic wave.

For reference's sake, FIG. 24D schematically shows a cross section of a waveguide device in which two hollow waveguides 430 are placed side-by-side. The two hollow waveguides 430 are electrically insulated from each other. Each space in which an electromagnetic wave is to propagate needs to be surrounded by a metal wall that defines the respective hollow waveguide 430. Therefore, the interval between the internal spaces 423 in which electromagnetic waves are to propagate cannot be made smaller than a total of the thicknesses of two metal walls. Usually, a total of the thicknesses of two metal walls is longer than a half of the wavelength of a propagating electromagnetic wave. Therefore, it is difficult for the interval between the hollow waveguides 430 (i.e., interval between their centers) to be shorter than the wavelength of a propagating electromagnetic wave. Particularly for electromagnetic waves of wavelengths in the extremely high frequency range (i.e., electromagnetic wave wavelength: 10 mm or less) or even shorter wavelengths, a metal wall which is sufficiently thin relative to the wavelength is difficult to be formed. This presents a cost problem in commercially practical implementation.

On the other hand, a waveguide device 100 including an artificial magnetic conductor can easily realize a structure in which waveguides 122 are placed close to one another. Thus, such a waveguide device 100 can be suitably used in an antenna array that includes plural antenna elements in a close arrangement.

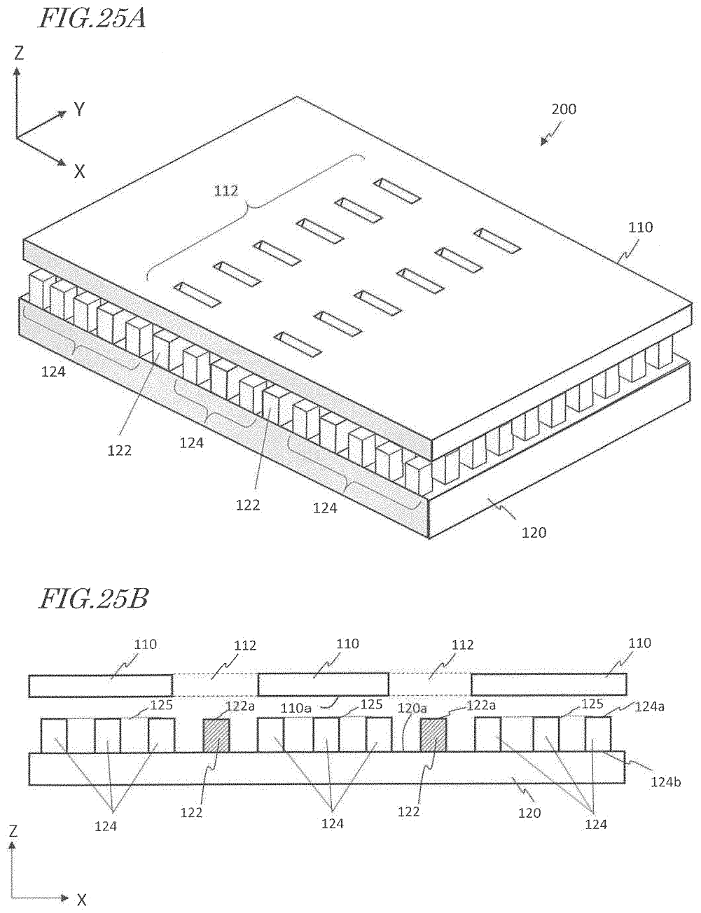

FIG. 25A is a perspective view schematically showing a portion of the construction of a slot antenna array 200 utilizing the aforementioned waveguide structure. FIG. 25B is a diagram showing schematically showing a portion of a cross section taken parallel to an XZ plane which passes through the centers of two adjacent slots 112 along the X direction of the slot antenna array 200. In the slot antenna array 200, the first conductor 110 has a plurality of slots 112 arranged along the X direction and the Y direction. In this example, the plurality of slots 112 include two slot rows, each slot row including six slots 112 arranged at an equal interval along the Y direction. On the conductor 120, two waveguides 122 extending along the Y direction are provided. Each waveguide 122 has an electrically-conductive waveguide surface 122a opposing one slot row. In a region between the two waveguides 122 and in regions outside of the two waveguides 122, a plurality of conductive rods 124 are disposed. These conductive rods 124 constitute an artificial magnetic conductor.

From a transmission circuit not shown, an electromagnetic wave is supplied to a waveguide extending between the waveguide surface 122a of each waveguide 122 and the conductive surface 110a of the conductor 110. Among the plurality of slots 112 arranged along the Y direction, the distance between the centers of two adjacent slots 112 is designed so as to be equal in value to the wavelength of an electromagnetic wave propagating in the waveguide, for example. As a result of this, electromagnetic waves with an equal phase can be radiated from the six slots 112 arranged along the Y direction.

The slot antenna array 200 shown in FIG. 25A and FIG. 25B is an antenna array in which the plurality of slots 112 serve as antenna elements (radiating elements). With such construction of the slot antenna array 200, the interval between the centers of antenna elements can be made shorter than a wavelength λo in free space of an electromagnetic wave propagating through the waveguide, for example. Horns may be provided for the plurality of slots 112. By providing horns, radiation characteristics or reception characteristics can be improved.

An antenna device according to an example embodiment of the present disclosure can be suitably used in a radar device or a radar system to be incorporated in moving entities such as vehicles, marine vessels, aircraft, robots, or the like, for example. A radar device would include an antenna device incorporating a waveguide device according to any of the above example embodiments and a microwave integrated circuit that is connected to the antenna device, e.g., MMIC. A radar system would include the radar device and a signal processing circuit that is connected to the microwave integrated circuit of the radar device. When an antenna device according to an example embodiment of the present disclosure and a WRG structure which permits downsizing are combined, the area of the face on which antenna elements are arrayed can be reduced, as compared to a construction in which a conventional hollow waveguide is used. Therefore, a radar system incorporating the antenna device can be easily mounted in a narrow place. Note that a radar system may be used while being fixed on the road or a building, for example. The signal processing circuit may perform a process of estimating the azimuth of an arriving wave based on a signal that is received by a microwave integrated circuit, for example. For example, the signal processing circuit may be configured to execute the MUSIC method, the ESPRIT method, the SAGE method, or other algorithms to estimate the azimuth of the arriving wave, and output a signal indicating the estimation result. Furthermore, the signal processing circuit may be configured to estimate the distance to each target as a wave source of an arriving wave, the relative velocity of the target, and the azimuth of the target by using a known algorithm, and output a signal indicating the estimation result.

In the present disclosure, the term “signal processing circuit” is not limited to a single circuit, but encompasses any implementation in which a combination of plural circuits is conceptually regarded as a single functional part. The signal processing circuit may be realized by one or more System-on-Chips (SoC). For example, a part or a whole of the signal processing circuit may be an FPGA (Field-Programmable Gate Array), which is a programmable logic device (PLD). In that case, the signal processing circuit includes a plurality of computation elements (e.g., general-purpose logics and multipliers) and a plurality of memory elements (e.g., look-up tables or memory blocks). Alternatively, the signal processing circuit may be a set of a general-purpose processor(s) and a main memory device(s). The signal processing circuit may be a circuit which includes a processor core(s) and a memory device(s). These may function as the signal processing circuit.

An antenna device according to an example embodiment of the present disclosure may also be used in a wireless communication system. Such a wireless communication system would include an antenna device incorporating a waveguide device according to any of the above example embodiments and a communication circuit (a transmission circuit or a reception circuit) that is connected to the antenna device. For example, the transmission circuit may be configured to supply, to a waveguide within the antenna device, a signal wave representing a signal for transmission. The reception circuit may be configured to demodulate a signal wave which has been received via the antenna device, and output it as an analog or digital signal.

An antenna device according to an example embodiment of the present disclosure can further be used as an antenna in an indoor positioning system (IPS). An indoor positioning system is able to identify the position of a moving entity, such as a person or an automated guided vehicle (AGV), that is in a building. An antenna device can also be used as a radio wave transmitter (beacon) for use in a system which provides information to an information terminal device (e.g., a smartphone) that is carried by a person who has visited a store or any other facility. In such a system, once every several seconds, a beacon may radiate an electromagnetic wave carrying an ID or other information superposed thereon, for example. When the information terminal device receives this electromagnetic wave, the information terminal device transmits the received information to a remote server computer via telecommunication lines. Based on the information that has been received from the information terminal device, the server computer identifies the position of that information terminal device, and provides information which is associated with that position (e.g., product information or a coupon) to the information terminal device.

Application examples of radar systems, communication systems, and various monitoring systems that include a slot array antenna having a WRG structure are disclosed in the specifications of U.S. Pat. Nos. 9,786,995 and 10,027,032, for example. The entire disclosure of these publications is incorporated herein by reference. A slot array antenna according to the present disclosure is applicable to each application example that is disclosed in these publications.

A waveguide device according to the present disclosure is usable in any technological field that utilizes an antenna. For example, it is available to various applications where transmission/reception of electromagnetic waves of the gigahertz band or the terahertz band is performed. In particular, they may be suitably used in onboard radar systems, various types of monitoring systems, indoor positioning systems, and wireless communication systems, e.g., Massive MIMO, where downsizing is desired.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A waveguide device comprising:
a first electrical conductor including a first electrically conductive surface; and
a second electrical conductor including a second electrically conductive surface opposing the first electrically conductive surface; wherein
the second electrical conductor includes:
a through hole;
a ridge-shaped waveguide protruding from the second electrically conductive surface, the waveguide including an electrically-conductive waveguide surface opposing the first electrically conductive surface, and one end thereof extending into the through hole; and
a plurality of electrically conductive rods protruding from the second electrically conductive surface, the plurality of electrically conductive rods being located on opposite sides of the waveguide, each including a leading end opposing the first electrically conductive surface;
the first electrical conductor or the second electrical conductor includes an electrically conductive wall protruding from the first electrically conductive surface or the second electrically conductive surface, the electrically conductive wall extending around the one end of the waveguide;
the electrically conductive wall includes an inner surface opposing an end surface at the one end of the waveguide and opposite side surfaces at the one end of the waveguide;
a first waveguide is between the waveguide surface and the first electrically conductive surface; and
a second waveguide is inward of the electrically conductive wall and inside the through hole, the second waveguide being connected to the first waveguide.

2. The waveguide device of claim 1, wherein
the second electrical conductor includes the electrically conductive wall;
the electrically conductive wall extends around the one end of the waveguide and around the through hole; and
the first electrical conductor includes a slit or recess accommodating at least a portion of the electrically conductive wall.

3. The waveguide device of claim 1, wherein
the second electrical conductor includes the electrically conductive wall;
the electrically conductive wall extends around the one end of the waveguide and around the through hole;
the first electrical conductor includes a slit or recess accommodating at least a portion of the electrically conductive wall; and
an interspace exists between an inner surface of the slit or recess of the first electrical conductor and a surface of the electrically conductive wall.

4. The waveguide device of claim 1, wherein
the second electrical conductor includes the electrically conductive wall;
the electrically conductive wall extends around the one end of the waveguide and around the through hole;
the first electrical conductor includes a slit or recess accommodating at least a portion of the electrically conductive wall; and
an interspace exists between an inner side surface of the slit or recess of the first electrical conductor and a side surface of the electrically conductive wall.

5. The waveguide device of claim 1, wherein
the inner surface of the electrically conductive wall includes:
a first inner surface opposing the end surface at the one end of the waveguide; and
a pair of second inner surfaces continuous with the first inner surface, respectively opposing the opposite side surfaces at the one end of the waveguide;
the second electrical conductor includes the electrically conductive wall;
the electrically conductive wall extends around the one end of the waveguide and around the through hole; and
the first electrical conductor includes a slit or recess accommodating at least a portion of the electrically conductive wall.

6. The waveguide device of claim 1, wherein
the first electrical conductor includes the electrically conductive wall; and
a portion of the electrically conductive wall is inside the through hole.

7. The waveguide device of claim 1, wherein
the inner surface of the electrically conductive wall includes:
a first inner surface opposing the end surface at the one end of the waveguide; and
a pair of second inner surfaces continuous with the first inner surface, respectively opposing the opposite side surfaces at the one end of the waveguide;
the first electrical conductor includes the electrically conductive wall; and
a portion of the electrically conductive wall is inside the through hole.

8. The waveguide device of claim 1, wherein
the waveguide is a first waveguide;
the second electrical conductor includes:
a third electrically conductive surface opposite to the second electrically conductive surface; and
a ridge-shaped second waveguide protruding from the third electrically conductive surface, one end of the second waveguide extending into the through hole so as to be continuous with the one end of the first waveguide;
a third waveguide extends along a top surface of the second waveguide; and
the third waveguide is connected to the second waveguide.

9. The waveguide device of claim 2, wherein
the waveguide is a first waveguide;
the second electrical conductor includes:
a third electrically conductive surface opposite to the second electrically conductive surface; and
a ridge-shaped second waveguide protruding from the third electrically conductive surface, one end of the second waveguide extending into the through hole so as to be continuous with the one end of the first waveguide;
a third waveguide is along a top surface of the second waveguide; and
the third waveguide is connected to the second waveguide.

10. The waveguide device of claim 1, wherein
the second electrical conductor includes the electrically conductive wall;
the waveguide is a first waveguide;
the electrically conductive wall extends around the one end of the first waveguide and around the through hole;
the first electrical conductor includes a slit or recess accommodating at least a portion of the electrically conductive wall;
an interspace exists between an inner surface of the slit or recess of the first electrical conductor and a surface of the electrically conductive wall;
the second electrical conductor includes:
a third electrically conductive surface opposite to the second electrically conductive surface; and
a ridge-shaped second waveguide protruding from the third electrically conductive surface, one end of the second waveguide extending into the through hole so as to be continuous with the one end of the first waveguide;
a third waveguide is defined along a top surface of the second waveguide; and
the third waveguide is connected to the second waveguide.

11. The waveguide device of claim 1, wherein
the second electrical conductor includes the electrically conductive wall;
the waveguide is a first waveguide;
the electrically conductive wall extends around the one end of the first waveguide and around the through hole;
the first electrical conductor includes a slit or recess accommodating at least a portion of the electrically conductive wall;
the second electrical conductor includes:
a third electrically conductive surface opposite to the second electrically conductive surface; and
a ridge-shaped second waveguide protruding from the third electrically conductive surface, one end of the second waveguide extending into the through hole so as to be continuous with the one end of the first waveguide;
a third waveguide is along a top surface of the second waveguide;
the third waveguide is connected to the second waveguide; and
the waveguide device includes a microstrip line connected to a portion of the top surface of the second waveguide.

12. The waveguide device of claim 9, further comprising:
a third electrical conductor including a fourth electrically conductive surface that is in contact with the third electrically conductive surface; wherein
the second electrical conductor includes a groove including an electrically-conductive inner surface at the third electrically conductive surface side;
the second waveguide is inside the groove; and
at least a portion of the top surface of the second waveguide is opposed to the fourth electrically conductive surface.

13. The waveguide device of claim 9, further comprising:
a third electrical conductor including a fourth electrically conductive surface opposing the third electrically conductive surface of the second electrical conductor; wherein
the second electrical conductor includes a plurality of second electrically conductive rods protruding from the third electrically conductive surface and being located on opposite sides of each of the plurality of second waveguides, each second electrically conductive rod including a leading end opposing the fourth electrically conductive surface; and
at least a portion of the top surface of the second waveguide is opposed to the fourth electrically conductive surface.

14. The waveguide device of claim 1, further comprising:
a third electrical conductor including a fourth electrically conductive surface that is in contact with the third electrically conductive surface; wherein the second electrical conductor includes the electrically conductive wall;
the waveguide is a first waveguide;
the electrically conductive wall extends around the one end of the first waveguide and around the through hole;
the first electrical conductor includes a slit or recess accommodating at least a portion of the electrically conductive wall;
the second electrical conductor further includes:
a third electrically conductive surface opposite to the second electrically conductive surface; and
a ridge-shaped second waveguide protruding from the third electrically conductive surface, one end of the second waveguide extending into the through hole so as to be continuous with the one end of the first waveguide;
a third waveguide is along a top surface of the second waveguide;
the third waveguide is connected to the second waveguide;
the second electrical conductor includes a groove including an electrically-conductive inner surface at the third electrically conductive surface side;
the second waveguide is inside the groove; and
at least a portion of the top surface of the second waveguide is opposed to the fourth electrically conductive surface;
the second electrical conductor further includes a second electrically conductive wall protruding from the third electrically conductive surface;
the second electrically conductive wall extends around the one end of the second waveguide and around the through hole; and
a top surface of the second electrically conductive wall is in contact with the third electrical conductor.

15. The waveguide device of claim 1, wherein
the second electrical conductor includes:
a plurality of through hole including the said through hole; and
a plurality of waveguides including the said waveguide;
the first electrical conductor or the second electrical conductor includes a plurality of electrically conductive walls including the said electrically conductive wall;
the plurality of electrically conductive rods are around and between the plurality of waveguides;
each of the plurality of waveguides is a ridge-shaped waveguide protruding from the second electrically conductive surface, including an electrically-conductive waveguide surface opposing the first electrically conductive surface, and one end thereof extending into one of the plurality of through holes;
each of the plurality of electrically conductive walls protrudes from the first electrically conductive surface or the second electrically conductive surface, and extends around the one end of one of the plurality of waveguides;
a plurality of first waveguides are defined between the waveguide surfaces of the plurality of waveguides and the first electrically conductive surface; and
a plurality of second waveguides respectively connected to the plurality of first waveguides are defined inward of the plurality of electrically conductive walls and inside the plurality of through holes.

16. The waveguide device of claim 15, wherein
the second electrical conductor includes the plurality of electrically conductive walls;
each of the plurality of electrically conductive walls extends around the one end of one of the plurality of waveguides and around one of the plurality of through holes; and
the first electrical conductor includes a plurality of slits or a plurality of recesses each accommodating at least a portion of a corresponding one of the plurality of electrically conductive walls.

17. The waveguide device of claim 15, wherein
the second electrical conductor includes the plurality of electrically conductive walls;
each of the plurality of electrically conductive walls extends around the one end of one of the plurality of waveguides and around one of the plurality of through holes;
the first electrical conductor includes a plurality of slits or a plurality of recesses each accommodating at least a portion of a corresponding one of the plurality of electrically conductive walls; and
at least one of the plurality of slits or the plurality of recesses includes an associated interspace between an inner surface thereof and a surface of one of the plurality of electrically conductive walls.

18. The waveguide device of claim 15, wherein
the second electrical conductor includes the plurality of electrically conductive walls;
each of the plurality of electrically conductive walls extends around the one end of one of the plurality of waveguides and around one of the plurality of through holes; and
the first electrical conductor includes a plurality of slits or a plurality of recesses each accommodating at least a portion of a corresponding one of the plurality of electrically conductive walls; and
at least one of the plurality of slits or the plurality of recesses includes an associated interspace between an inner side surface thereof and a side surface of one of the plurality of electrically conductive walls.

19. The waveguide device of claim 16, wherein
the plurality of waveguides include two adjacent waveguides;
the plurality of electrically conductive walls include two adjacent electrically conductive walls; and
the two electrically conductive walls include a common portion located between the respective one end of the two adjacent waveguides.

20. The waveguide device of claim 19, wherein the common portion includes, at a top thereof, a groove extending along a direction that the two waveguides extend.

21. An antenna device comprising:
the waveguide device of claim 2; and
one or more antenna elements element connected to the waveguide device.

22. The antenna device of claim 21, wherein
the first electrical conductor includes one or more slots defining the one or more antenna elements element; and
the one or more slots are opposed to the waveguide surface of the waveguide.

23. A communication device comprising:
the antenna device of claim 21; and
a microwave integrated circuit connected to the antenna device.
